(19) United States
(12) Patent Application Publication
(10) Pub. No.: US 2012/0078742 A1
(43) Pub. Date: Mar. 29, 2012

(54) System and method for generating leads for the sale of goods and services

(75) Inventor: Steven Robert Oleen, Mansfield, OH (US)

(73) Assignee: What's In It For Me.Com LLC

(21) Appl. No.: 13/309,105

(22) Filed: Dec. 1, 2011

Related U.S. Application Data
(63) Continuation-in-part of application No. 12/390,854, filed on Feb. 23, 2009.
(60) Provisional application No. 61/030,394, filed on Feb. 21, 2008.

(51) Int. Cl. G06Q 30/06

(52) U.S. Cl. 705/26.1

(57) ABSTRACT

A system and method for facilitating the collection and processing of sales referral information from any individual other than the actual buyer, but possessing specific intelligence pertaining to the imminent purchase of at least one of a good or a service, and a name and contact information of a buyer, a scope of work, and current vendor identification. The buyer is capable of accessing and amending the anonymously submitted information and receiving useful intelligence about potential vendors and products prior to contact. The vendors are capable of accessing one or more referrals to review the scope of work prior to purchasing the remaining information as originally submitted, or the buyer-amended information, with the identity of the lead source remaining anonymous to both the buyer and the vendor. Current vendors of the buyer may be notified in the event that the buyer is seeking a competitive quote.

### CROSS REFERENCE TO RELATED APPLICATIONS

This application is a continuation-in-part of U.S. patent application Ser. No. 12/390,854, filed Feb. 23, 2009, which claims priority to U.S. provisional application Ser. No. 61/030,394 filed on Feb. 21, 2008, the entirety of which are incorporated by reference herein.

### TECHNICAL FIELD

The disclosed embodiments are generally directed to the accumulation and processing of information specific to the imminent purchase of any one of a product or of a service in the marketplace. They are more specifically related to systems and methods to facilitate the exchange of information related to imminent sales events. This information exchange can be particularly beneficial to parties otherwise unknown to each other. However, it is to be appreciated that the present exemplary embodiments are also amenable to other like applications.

### BACKGROUND

Every day, millions of sales transactions take place across the United States and throughout the world. A large quantity of these sales transactions are completed between business/residential customers and Vendors with dedicated inside or outside sales personnel. In other words, sales transactions that take place outside of the traditional retail store environment. Examples of products sold during these types of transactions include business products such as, for example, telephone systems, copy machines, computers, office machines, software, office furniture, and the like. Other examples can be found in the building and construction trades such as, for example, electrical, plumbing, HVAC, steel erection, masonry, building construction, and the like. Further examples can also be found in service industries such as, for example, landscaping and lawn care, IT services, office cleaning services, facilities and machinery maintenance, and the like. The list is endless. Success or failure for these Vendors is based on their ability to locate and make contact with prospective customers.

The normal sales cycle includes the steps of prospecting, approaching, interviewing, presenting, and closing. Prospecting is the first step for the sales person in identifying prospects (prospective Buyers) for any given product or service. Prospecting includes, but is not limited to, advertising, promotion, finder's fees, telemarketing calls, pre-approach letters, door-to-door canvassing. Prospecting is by far the most difficult, time consuming, and expensive portion of the sales process. The approach to the prospective Buyer with the intention of setting an appointment to meet and discuss a sales person's product or service is critical to the sales process going forward.

If, however, prime buying motives have not been discovered, the close becomes more difficult and could result in a turning point in the sales process where the prospect begins to favor a competitor or a change in enthusiasm for your product or service.

The step of prospecting in the sales cycle is the most expensive and difficult to master and manage. A large amount of every Vendor's budget is dedicated to prospecting and approaching prospective Buyers at a time that is conducive to starting the sales process. This cost of prospecting by sales people comprises a significant part of the selling price of any product or service, which is a part of the direct cost of sales. To improve the step of prospecting, many sales organizations provide incentives or finder's fees that are offered to people outside the Vendor's organization, who provide information, tips and sales leads that result in a sale.

Most referral agencies, however, do not have complete or timely information. Rather, the typical agency begins with void or bad contact information (e.g., names, positions, addresses, phones, email addresses, etc.) and attempts to make it current and correct, without any information relative to whether such a contact is interested in purchasing. Additionally, most individuals will not risk offending their acquaintance, friend, or employer, by voluntarily taking part in their business when they have not been asked to participate. A large portion of the direct cost of sales is also spent on advertising efforts and other marketing methods. Repetitious and full market advertising coverage is expensive and designed to help prospects think of a specific product and/or Vendor when the purchase of a particular product or service is required.

In other circumstances, a Vendor may lose existing customers due to pricing issues, competitor incentives, an unsatisfactory experience, or the like. It is likely that the Vendor will not learn of a customer's dissatisfaction with the Vendor until the customer has switched to a new Vendor. The Vendor may be unaware of any problems, or aware of the problems and in the process of remedying the issues when the customer begins searching for a replacement Vendor. During such times, foreknowledge of the “shopping” by the customer may enable the Vendor to contact the customer directly, so as to remedy the problems perceived by the customer, thereby saving the customer time and money, preventing the Vendor losing a valued customer, and the like.

Accordingly, for at least the above referenced deficiencies, there is a need for systems and methods to generate higher quality sales leads.

### BRIEF DESCRIPTION

In one aspect, a system for collecting and processing sales referral information. The system includes a processor that has access to associated memory. The associated memory stores an associated database that comprises vendor information corresponding to a plurality of vendors, lead source information, sales lead information corresponding to a plurality of projects, and buyer information. The system also includes memory that is in communication with the processor, which stores instructions which are executed by the processor. The instructions are for receiving sales lead information corresponding to an imminent purchase of a good or a service from a lead source, the sales lead information including an identity of a corresponding buyer, an identification of at least one of a good or a service, a scope of work, and an identification of a current vendor associated with the identified at least one good or service. The instructions are also for comparing the received sales lead information to sales lead information corresponding to the plurality of projects stored in the associated database, and comparing the identification of the current vendor to plurality of vendors stored in the associated database so as to identify a match therebetween in response to a result of the sales lead information comparison. In addition, the instructions are for notifying an identified matching vendor of the received sales lead information in accordance with a result of the comparison of the current vendor, and for communicating a portion of the sales lead information to at least one of the plurality of vendors, the portion of the sales lead information comprising the scope of work. Furthermore, the instructions are for receiving, in response to the communicated portion of the sales lead information, a purchase of the sales lead information from at least one vendor of the plurality thereof, and for communicating a remaining portion of the sales lead information to the at least one vendor of the plurality thereof in response to the received purchase request.

In another aspect, a method for collecting and processing sales referral information, includes collecting, with a processor, vendor information corresponding to a plurality of vendors, lead source information, sales lead information corresponding to a plurality of projects, and buyer information, and storing the collected information in an associated database in communication with the processor. The method also includes receiving sales lead information corresponding to an imminent purchase of a good or a service from a lead source, and verifying the received sales lead information is representative of a new project in accordance with a comparison of the received sales lead information to sales lead information corresponding to the plurality of projects stored in the associated database. The method further includes storing the verified received sales lead information as a new project in the associated database, receiving a response from the buyer corresponding to the sales lead information indicating at least one of a valid or a bogus sales lead information, and communicating a portion of the sales lead information to at least one of the plurality of vendors responsive to a response from the buyer indicating valid sales lead information, the portion of the sales lead information comprising the scope of work. In addition, the method includes receiving, in response to the communicated portion of the sales lead information, a purchase of the sales lead information from at least one vendor of the plurality thereof, and communicating the remaining portion of the sales lead information to the at least one vendor of the plurality thereof in response to the received purchase request.

In still another aspect, a non-transitory computer-readable medium carrying computer code which controls one or more processors to collect vendor information corresponding to a plurality of vendors, lead source information, sales lead information corresponding to a plurality of projects, and buyer information and store the collected information in an associated database. The one or more processors further receive sales lead information corresponding to an imminent purchase of a good or a service from an anonymous lead source, the sales lead information including an identity of a corresponding buyer, an identification of at least one of a good or a service, a scope of work, and an identification of a current vendor associated with the identified at least one good or service, and verify the received sales lead information is representative of a new project in accordance with a comparison of the received sales lead information to sales lead information corresponding to the plurality of projects stored in the associated database. The non-transitory medium further carries instructions to store the verified received sales lead information as a new project in the associated database, to compare the received sales lead information to sales lead information corresponding to the plurality of projects stored in the associated database, and to compare the identification of the current vendor to plurality of vendors stored in the associated database so as to identify a match therebetween in response to a result of the sales lead information comparison. In addition, the instructions control the one or more processors to notify an identified matching vendor of the received sales lead information in accordance with a result of the comparison of the current vendor, to receive a response from the buyer corresponding to the sales lead information indicating at least one of a valid or a bogus sales lead information, and to modify a value associated with the sales lead information in accordance with a response from the buyer indicating validation of the sales lead information. Furthermore, the non-transitory medium carries instruction which control the one or more processors to communicate a portion of the sales lead information to at least one of the plurality of vendors, the portion of the sales lead information comprising the scope of work, to receive, in response to the communicated portion of the sales lead information, a purchase request from at least one vendor of the plurality thereof, and to communicate a remaining portion of the sales lead information to the at least one vendor of the plurality thereof in response to the received purchase request.

In accordance with another aspect, a non-transitory computer-readable medium carrying instructions which control one or more processors to generate a web interface to facilitate the collection and processing of sales referral information from any individual, other than an actual Buyer, but not excluding the actual Buyer and possessing specific intelligence pertaining to the imminent purchase of at least one of a good or a service, a name and contact information associated with the Buyer, a “Scope of Work,” and current Vendor identification. A web interface source code segment facilitates the presentation of content to a user that accesses the web interface and allows the reception of data provided by the user to interface with the sales lead system. A Lead Source module allows a Lead Source to add lead information to the sales lead system, the Lead Source module is configured to receive Lead Source information related to an imminent purchase of at least one of a good or a service by a prospective Buyer, and a name of the prospective Buyer. A Vendor module allows one or more Vendors to access one or more leads and/or interface with the prospect to receive additional information related to the lead, wherein the one or more Vendors are not provided with information to identify the Lead Source.

In another aspect, a method is employed to facilitate interactions between a Vendor and a Buyer via a sales lead system. A Sales Lead is received from an anonymous Lead Source via an interface coupled to a network; the Sales Lead is related to an imminent purchase of at least one of a good and a service by a prospective Buyer, and a name of the prospective Buyer. The prospective Buyer is contacted via email and informed that their imminent purchase has been anonymously reported. The Buyer is then invited to validate and amend information contained in the received Sales Lead. Subscribing Vendors are then informed that a Buyer validated or non-validated Sales Lead is available for inspection via the interface. Information related to one or more Vendors is received via the interface coupled to the network, the one or more Vendors sell goods and/or services. The Sales Lead is matched to at least one of the Vendors via a server coupled to the network. The “Scope of Work” portion of the Sales Lead is sent to all subscribing Vendors requesting Sales Leads from a particular geographical area defined by zip code. The Scope of Work provides subscribing Vendors with enough information to determine the suitability and desirability of the Sales Lead. Vendors are then provided an opportunity to purchase the identity and remaining information of the prospective Buyer associated with the Sales Lead.

The identity of all Vendor members who purchased the Sales Lead is provided to the Validating Buyer with specific background information including the history, experience and suitability of those Vendors who purchased the information of the Sales Lead and are likely to make contact with the purpose of offering their goods and services. Furthermore, a Validating Buyer will share in the proceeds of the Sales Lead purchased by Vendors.

In another aspect, a non-transitory computer-readable medium carrying instructions which control one or more processors to warn a subscribing Vendor with an existing customer base by notifying the Vendor when an existing customer of the Vendor is identified as the Buyer in a Sales Lead, such that the Buyer is actively seeking a competitor to service their account and in sufficient time for the current Vendor to correct or repair the Vendor/Buyer relationship and maintain the Buyer as a customer of the Vendor. When a Sales Lead is received by an interface associated with a Service Provider, the information of which includes the identity of the prospective Buyer's current Vendor, whereby that Vendor, if a member, is immediately notified that their existing customer is “shopping” them.

In another aspect, a Buyer of any good or service can reveal their intent to purchase a product or service for the purpose of streamlining their own purchasing process with Vendors and manufacturers whereby an interface associated with a Service Provider provides product research and competitive quotes for products and services.

### BRIEF DESCRIPTION OF THE DRAWINGS

FIG. 1 illustrates a system to allow a Lead Source and a Vendor to interface, in accordance with an exemplary embodiment.

FIG. 2 illustrates a registration component that allows a new member to register with the system, in accordance with an exemplary embodiment.

FIG. 3 illustrates an authentication component that allows existing users to access the system, in accordance with an exemplary embodiment.

FIG. 4 illustrates a general member module that allows undesignated users to interface with the system, in accordance with an exemplary embodiment.

FIGS. 5A, 5B and 5C illustrate a Lead Source module that allows a user to enter information relating to an impending purchase event, in accordance with an exemplary embodiment.

FIG. 6 illustrates a Vendor module that allows a user to provide information related to goods or services they provide, in accordance with an exemplary embodiment.

FIG. 7 illustrates a customer interface module that allows a customer to provide information related to impending sales events and/or rate one or more Vendors within the system, in accordance with an exemplary embodiment.

FIG. 8 illustrates administrative functionality of the system, in accordance with an exemplary embodiment.

FIG. 9 illustrates administrative functionality of the system, in accordance with an exemplary embodiment.

FIG. 10 illustrates an information center that provides specific information to system users, in accordance with an exemplary embodiment.

FIG. 11 illustrates an exemplary web interface, in accordance with an exemplary embodiment.

FIG. 12 illustrates an exemplary lead form, in accordance with an exemplary embodiment.

FIG. 13 illustrates an exemplary interaction with a sales lead system in accordance with one embodiment.

### DETAILED DESCRIPTION

The embodiments described herein include is a systems and methods for generating sales leads. Other embodiments discussed hereinafter enable the reporting to a Vendor of existing customers seeking competitive quotes for goods or services currently being supplied by the Vendor.

The following definitions are intended to assist in the understanding of the subject embodiments. It will be appreciated that modification

A “Lead Source” is intended to comprise any individual of legal age with access to a computer and the Internet. Lead Sources are individuals who have information about a party's (person, company, or the like) intent to purchase any product or service and are pre-disposed to sharing that information with the Service Provider (defined below) in exchange for a financial or other type of reward. Lead Sources will join a service hosted by the Service Provider and agree to a specific set of rules. In accordance with varying embodiments described hereinafter, a fee or no fee may be charged to the Lead Source upon joining the service.

A “Vendor” is a sales representative for a particular product or service who is seeking information about prospective customers, or “Buyers” (as defined below), of that product or service. The information sought by the Vendor includes, but is not limited to: an immediate need for their product or service, an intent to buy, the ability to afford and the authority to purchase or to strongly influence the purchase, of a particular product or service. In some embodiments set forth herein, Vendors may incur a membership fee, e.g., a subscription, in order to review and purchase Sales Leads (as defined below).

A “Buyer”, e.g., a customer, may be any individual, representing himself or a business entity, that is actively and currently in the market to purchase any product or service where the purchase of that product or service is at best, imminent; at worst probable. In the embodiments described in greater detail below, a Buyer may or may not incur a fee to join the service, i.e., become a member.

A “Validated Buyer” may be any Buyer that affirmatively agrees to take part in the bid solicitation process by confirming information associated contained in the Sales Lead, including, for example and without limitation, the probable or imminent purchase of the goods or services identified in the Sales Lead, supplies corrections and/or additions to the lead information in the Sales Lead as submitted to Service Provider by the Lead Source.

A “Sales Lead” comprises, for example and without limitation, the detailed information about the imminent purchase of any product or service as submitted by the Lead Source. The Sales Lead may include customer contact information, Current Vendor information, product/service identification, purchase timeframe, and additional information known or believed by the Lead Source.

A “Project” is a Sales Lead that has been determined to be legitimate through internal database verification that has been assigned to the originating Lead Source member.

A “Lead Form” is an electronic form collecting general or industry specific information that is completed by the originating Lead Source when a Sales Lead is first reported to the Service Provider.

A “Scope of Work” comprises of all information that is specific to the Project as reported by the Lead Source. This information is sufficient to allow Vendor members to determine whether or not to purchase the Sales Lead. This information may or may not be validated by the Buyer.

A “Current Vendor” corresponds to the identity of the Buyer's current Vendor, reported on the Lead Form. This information is used to assist other Vendor members determine if their existing customers are “shopping” them.

“Anonymous Lead Source” corresponds to a Lead Source that has elected to remain anonymous. According to one embodiment, Sources are provided the option to make their identities known to Vendors and assume that permission is granted for Vendors to use their name when contacting Buyers. Those Lead Source members who do not want their identities made known, will remain anonymous.

“Imminent” corresponds to actively seeking to purchase any product or service. It is contemplated herein that the information from the Lead Source or contained in the Lead Form about the Buyer is ascertained from others who are intimate with the Buyer and the associated intent to buy. The purchasing process will have begun when this information is submitted and the Buyer will have already made the decision to purchase. Although the actual date of a purchase may or may not be revealed, the decision to consummate a sale has been made and is considered to be imminent.

A “Bogus Lead” represents a Sales Lead, i.e., information, which is known to be false when submitted and determined to be false by Vendors.

A “Project Database” is maintained by the Service Provider, The Project Database may include, for example and without limitation, information of all Sales Leads and/or Projects that are reported by Lead Source members. All subsequent information received is archived, analyzed and/or stored for later retrieval.

“Shopping” represents circumstances or action wherein an existing Buyer, e.g., customer, is seeking competitive quotes for products and services from Vendors other than the Current Vendor, i.e., the Vendor currently providing that product or service to Buyer.

A “Decision Maker” may comprise an individual having the authority to consummate a purchase of a product or service on his own behalf or on the behalf of a business or institutional entity he represents, e.g., on behalf of the Buyer.

A “Decision Influencer” corresponds to a person who may be someone with a strong influence with the ultimate Decision Maker for the final purchase of a product or service, e.g., a Comptroller's influence on the CEO's decision to buy.

A “Service Provider” may comprise the backend systems and components to facilitate the functioning of the systems and methods described in greater detail below. The Service Provider may include one or more servers operable to host one or more websites to allow for submittal of a Sales Lead by a Lead Source, receive information from the Buyer, and the like. Additional features and functions of the Service Provider are discussed in greater detail below.

A website business, i.e., the Service Provider, has a website dedicated to Sales Lead generation for all types of selling organizations (Vendor) unaffiliated with the Service Provider but registered with the website. Sales Leads are generated and reported to the website by individuals with information about the potential purchase of any product or service (Lead Source) by any other individual, company, institution or government entity (Buyer). The Lead Sources that report Sales Leads to the Service Provider do not have to be directly involved in the purchase of any product or service, they simply need to have knowledge of the potential yet imminent sale. For example, a neighbor who hears that another neighbor is looking for a roofer or a lawn care service, a secretary who hears that her employer is looking to replace their business telephone system or purchase new office furniture, or an acquaintance who mentions that they are in need of a new insurance company—all are excellent examples of bona-fide Sales Leads. Everyone has “insider” knowledge about someone else's intention to buy something, and this information, however incomplete, is valuable to those who have products and services to sell (Vendors). According to one embodiment discussed herein, Sales Leads are generally categorized by sales professionals as being a “tip,” a “lead,” or a “Referral,” in an ascending order of importance and value, and are differentiated by the amount of useful information that is available to the sales person.

The most valuable of all sales leads is a referral, whereby there is present: (1) an immediate need for a product or service, (2) the ability to pay for, or afford the product or service, and (3) the identity of the person with the authority to say “yes” to the purchase. The embodiments set forth herein generate the highest form of a referral-type Sales Lead whereby the actual “intent to buy” and “an invitation to call” is created from all forms of Sales Leads, even the “tip,” where only limited information is initially known. This enhanced form of Sales Lead is referred to as an “APIX” sales lead. An “APIX” lead is a Class A Sales Lead with a known Intent to Buy and an Invitation to Call.

The systems and methods according to the embodiments described herein is designed to assist and encourage people to willingly and enthusiastically share that type of information with the Service Provider, whereupon the Service Provider will enthusiastically share the information with Vendors who are willing to pay a nominal finder's fee for the information. Furthermore, the information provided by the Lead Sources may still be construed as “raw” information and although is a bona-fide Sales Lead, is not as yet confirmed and validated.

There is currently no known, national, forum, established for all product and service categories, where anyone can report someone else's intent to buy. This type of forum does not exist for three very simple yet important reasons. First, most people will not risk offending their acquaintance, friend, or employer, by voluntarily taking part in their business when they have not been asked to participate. Second, there is no advantage, other than the act of friendship if asked to participate, either material or financial, for a person to do so. Third, there is nothing to compel a prospective Buyer to validate, correct, and amend any information that was submitted by a third party. It is these three challenges that if overcome, creates an entire new system and method of prospecting for sales organizations in all direct sales industries, regardless of product or service. Varying embodiments discussed below address these challenges and provides exactly that type of forum for everyone, providing they have access to the Internet.

According to one embodiment, the Service Provider establishes a website that is an on-line sales lead generator that collects and distributes highly sought after and detailed customer specific information about prospective customers, i.e., Buyers, of any product or service. These Sales Leads may be sent directly to a Vendor's sales representative in the field, within their own sales territory in a timely fashion. This information is gathered from Lead Sources at a time when prospective customers, i.e., Buyers, are actively “in the market” with the stated or considered intent to purchase. The Lead Source obtains the information anytime anyone who is considering a purchase mentions it to them, or in some manner they are privy to insider information. Any Lead Source, e.g., an individual registered with the Service Provider and having specific knowledge of any other individual or company's intent to purchase any product or service, is encouraged to confidentially and with assurance of anonymity, register that Buyer (prospective customer) with the Service Provider. In accordance with one embodiment, the Buyer is not informed as to the identity of the Lead Source, the Lead Source is not informed of the identity of the Vendor, and the Vendor is not informed of the identity of the Lead Source.

In such an embodiment, a website of the Service Provider serves as a protective wall between these parties to assure anonymity, wherein security measures such as, for example, encryption techniques are employed to insure confidentiality. The website may be encrypted so that each character and symbol in all confidential information is encrypted (e.g., via an RC4 encryption method) and the key to begin the process is not known to any one individual. Buyers are contacted by the Service Provider via the website and offered the opportunity to receive product and Vendor satisfaction information, and to take part in the sales process, prior to the Sales Lead being distributed to a Vendor registered with the website. A Buyer is directed to their own unique Project on the website. It will be appreciated that when such prospective Buyers take part in the process and further validate and amend the information as anonymously submitted by a Lead Source, the value of the Sales Lead to Vendors is increased, which increase is paid to Buyers upon purchase of the Sales Lead by Vendors. Advertisers are able to present product-specific advertising directly at, and only at APIX Buyers with the expressed intent to purchase any product or service, and before Vendors of that product even know that they are “in the market.”

Note that an APIX Buyer is someone who (1) has an immediate and expressed need for a particular product or service, (2) can afford a particular product or service, (3) has the authority to say “yes” to the purchase of a particular product or service, and (4) will extend an invitation to appropriate Vendors. This process actually includes the Buyer in the sale before the sales person or Vendor, even knows they are in the market to buy. Subscribing Vendors will receive the Scope of Work of every referral as submitted by Lead Sources, validated or not, and will have an opportunity to purchase the identification and other information, based on the Scope of Work and its suitability for their focus. The price of each referral is based on industry accepted norms for information of this type and on whether the Buyer has validated the lead information of the Lead Source or not. Lead sources are preferably not privy to this information.

The system and method according to the present invention works as follows. Any individual or entity (Lead Source) with information that another individual or company (Buyer) is contemplating the purchase of any product or service, can anonymously register that information as a Sales Lead with the Service Provider's, e.g., via the hosted website. If no one else has already registered that identical Sales Lead, then a Project is created, and the registering Lead Source will receive compensation from Vendors who purchase the Sales Lead. All Vendors receiving the Sales Lead will choose to purchase the identification information; the cumulative total of fees collected from all Vendors for the Sales Lead will be distributed to the Lead Source, and to the validating Buyer (if one is associated with the Project).

Once a lead has been submitted, it will be presented directly to those registered Vendors for that particular product or service category requesting leads from that particular geographic territory. Vendors, upon receiving the Scope of Work for each Sales Lead, will choose which Sales Leads they wish to purchase and subsequently will receive the remainder of the Buyer identification and other pertinent information

The website is preferably designed to interact with three distinct categories of participants: Lead Sources, Vendors, and Buyers. As mentioned above, the Lead Sources are people or entities having “insider” information about the intent of another person or company who is in the market, or about to enter the market, to purchase any product or service, the information of which would be valuable to any Vendor who sells that particular product or service. Vendors are companies or individuals who sell their products or services by means of a direct, inside or outside sales force, dedicated to discovering and making contact with prospective Buyers for their product or service. The Buyers are companies or individuals who are actually in the market, or about to enter the market, for a particular product or service that is sold by Vendors.

The systems and methods according to the embodiments set forth herein have several unique attributes. A first attribute is the ability to allow the Lead Source to remain completely anonymous. The Service Provider does not reveal any Lead Source information to a Vendor or a Buyer without the permission of the Lead Source. Because anyone can be a Lead Source, and each Lead Source has the option to remain anonymous to Vendors and Buyers alike, there is no fear of being “discovered.” As a result, literally anyone with access to the Internet and the website hosted by the Service Provider can participate in sharing in the cost of sales. It will be appreciated that is no better Sales Lead available than one that is produced and reported as soon after a prospective Buyer first articulates his/her desire to purchase as possible. A second attribute is the ongoing income potential for the Lead Source. All finder's fees are shared with the Lead Source and the Buyer. Every Sales Lead generated can earn a finder's fee that is paid directly to registered Lead Sources and Validating Buyers by the Service Provider. As a result, a significant income can be earned by anyone and the ultimate purchase price is reduced to Validating Buyers. Additionally, if the Buyer registers his own Project as a Sales Lead, then the final cost of the product or service to them is further reduced. A third attribute is that a Buyer will be informed as to which Vendors have purchased the Sales Lead for their Project and will be provided with background information and Vendor research before Vendors call on them. That is Buyers, as willing participants in the process, have made available to them product and Vendor research prior to any Vendors calling on them, thus dramatically reducing the cost to purchase products and services thus assuring a “maximum competitive effect.” A fourth attribute is that if a subscribing Vendor has a customer that is reported to the website as a new Sales Lead (i.e., the identified Buyer of the new Sales Lead), that Vendor will be notified immediately that their existing customer may be dissatisfied and is “Shopping” them, thus giving that Vendor an opportunity to retain their customer. This process allows Vendors an opportunity to improve their service and/or their pricing in a timely manner. A fifth attribute is the willing participation of the prospective Buyer before the Vendors are even aware that a Sales Lead has been created. Buyers are invited and encouraged to take part in the process before the Sales Lead is forwarded to Vendors. This allows the Buyer to have some control over who calls on them and when, and even presents them with valuable Vendor and product satisfaction reports on the very Vendors they are about to hear from.

A sixth attribute is additional information made available to the Buyers. With the Buyers' participation, an entire new market is opened by the Service Provider. In one example, products such as Vendor satisfaction and product satisfaction reports are offered for purchase by the Buyer before selected Vendors are even notified that the Sales Lead exists. In another example, Vendor satisfaction and product satisfaction reports are offered for no cost to the Buyer as an enticement to take part in their own sales cycle, if this Buyer has been reported as a current Project.

Plus other timely business-to-business services are offered that further enhance the Buyer's purchasing experience and help them become a more informed customer. Some of these business-to-business sales services can include: product video presentations by Vendors and full motion, real-time video conference presentations, Vendor-to-Buyer and Vendor-to-Lead Source chat and email integration, etc. A seventh attribute is Vendor membership levels through which Vendors are provided with information in additional to the initial Lead. The additional information can be, for example, up-to-date sales process information, including competitor's progress and Buyer's responses the Vendor has enrolled in an appropriate membership level.

Although there are preferably Vendor membership levels that can be purchased based on additional services offered, there preferably is no charge to a Vendor for a basic Level I membership to receive Sales Leads. Lead Sources that provide bogus or false leads will be barred from participating in website services in the future.

It is also apparent from the foregoing disclosure that the systems and methods of the subject embodiments address the enormity of the prospecting step of the sales cycle which is the most expensive and most difficult step to master and manage. By directly “tapping” into the intent of a Buyer and gathering the critical information about the prospective Buyer early, much of the expense and challenge of prospecting is eliminated. The systems and methods of the subject embodiments also provide valuable and never-before-available information specifically about APIX referrals. Additionally, attractive incentives and encouragement are provided for Lead Sources to discover how best to make the approach as well as some of the prime buying motives that will be critical at the time of closing.

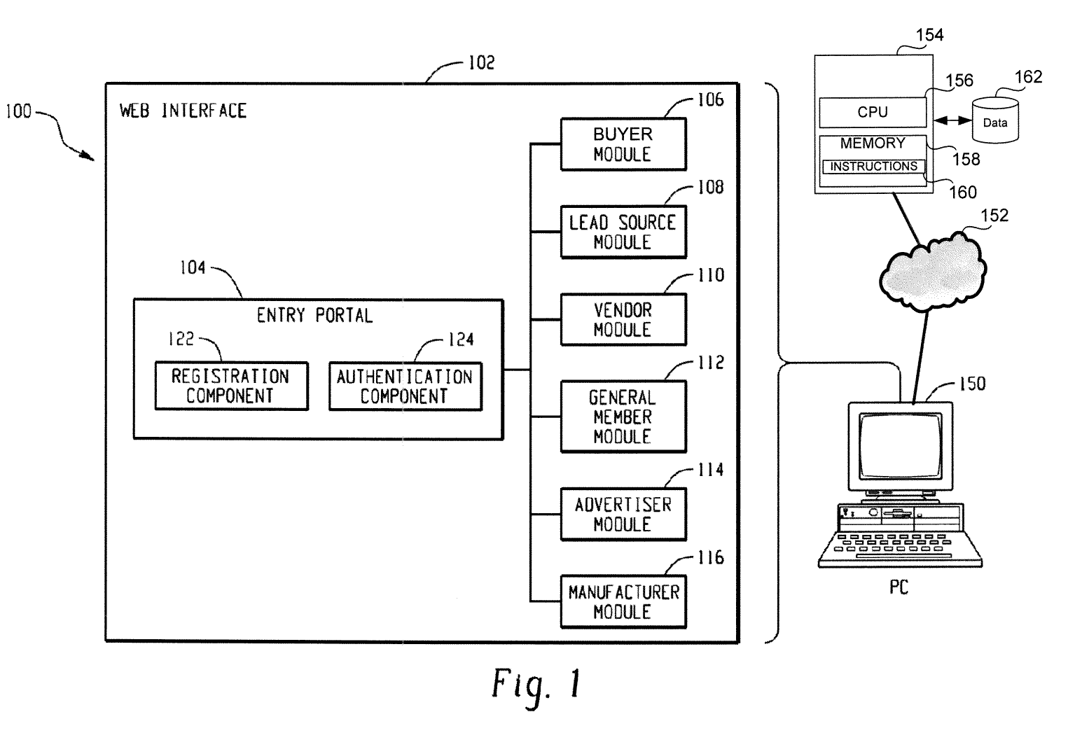

FIG. 1 illustrates a system 100 that facilitates the collection and processing of sales referral information, e.g., Sales Leads. The system 100 further facilitates interaction of a Lead Source and a Vendor with a Service Provider in order to enable the Vendor and a Buyer identified in the Sales Lead by the Lead Source to subsequently interact with respect thereto. It will be appreciated that the various components depicted in FIG. 1 are for purposes of illustrating aspects of the exemplary embodiment, and that other similar components, implemented via hardware, software, or a combination thereof, are capable of being substituted therein. In this manner, prospective Buyers who are unaware of Vendors selling a particular product and Vendors unaware of prospects requiring such a product can be brought together to engage in interactions that may or may not result in a sales transaction. The system 100 includes a web interface 102 that allows a user to access the system over a network. In one example, the web interface 102 is accessible via a wide area network, local area network, and/or the Internet via a wireless or wired connection.

The web interface 102 includes an entry portal 104 that allows a user to access the information related to a party with a service/good requirement (e.g., a prospective Buyer) and a service/good provider (e.g., a Vendor). The entry portal 104 also allows a Lead Source to provide information that is specific to one or more prospective Buyers. The information can identify the name of the prospective Buyer (ABC Company), the good and/or service sought (widgets), and a contact that has authority to make such a purchase (CEO Jeff Smith). The Lead Source can also include information such as a deadline for resolution of the need, budget restrictions, and whether the Lead Source can be identified to the prospective Buyer, for example. In this manner, the system 100 can allow a Vendor and a prospective Buyer, which may be previously unknown to one another, to interface based on a Sales Lead to determine if a transaction can be completed. If so, the prospective Buyer becomes a customer of the Vendor.

The entry portal includes a registration component 122 and an authentication component 124. The registration component 122 allows a user that is new to the system 100 to create an account in order to interface with other members. The authentication component 124 allows existing users to enter the system via one or more authentication algorithms (e.g., a username and password). For each user type, a particular module can be employed to utilize the entry portal 104 to access the web interface 102. It is to be appreciated that although six user types are specified, a plurality of disparate user types apparent to one skilled in the art can be employed. For exemplary purposes, a user can be categorized as a Buyer, a Lead Source, a Vendor, a general member, an advertiser, and/or a manufacturer. Each user in turn can interface with the system 100 via one of six modules, namely, a Buyer module 106, a Lead Source module 108, a Vendor module 110, a general member module 112, an advertiser module 114, and a manufacturer module 116. In this manner, a user is identified for participation with the system 100 that is pertinent to their specific user type.

The system 100 can track and manage information provided by a Lead Source. This Lead Source information is delivered to one or more qualified Vendors that meet a predetermined set of criteria. For instance, the Vendor must have the same category of goods and location as the prospective Buyer. In one embodiment, the Lead Source may receive compensation upon the purchase of the Sales Lead by one or more Vendors. In one example, the Lead Source is paid a predetermined percentage of the total amount of the fees collected from Vendors for the submitted Sales Lead. In another example, the user is paid a flat fee for the information provided via the Sales Lead. In still another example, the Lead Source may be paid a flat fee per purchase of the Sales Lead by the Vendors, i.e., a flat fee for each purchase made by Vendors.

Alternatively or in addition, the Lead Source can be barred from receiving certain information related to the interactions between the Vendor and the Buyer. This limitation of information dissemination can deter the system 100 from facilitating bidding wars between Vendors. Further, this restriction can allow a Lead Source to feel comfortable in providing information related to a particular requirement without allowing other members from otherwise unfairly capitalizing on the information provided by the Lead Source.

The Buyer module 106 permits a prospective Buyer to validate information contained within a Sales Lead, e.g., validate the information provided to the system 100 by a Lead Source, including, for example and without limitation, the imminent intent to purchase. In one example, the Buyer is notified, via email or other means, that an anonymous Lead Source has provided information to the system 100. This notification allows a Buyer to interface with the Service Provider so as to confirm information in the Sales Lead and/or to provide additional details related to their particular requirement. This early interaction between the Buyer and the Service Provider facilitates the dramatic enhancement of information contained in the originally submitted Sales Lead, which thereby increases the value associated with the Sales Lead to one or more Vendors. It will be appreciated that such enhancement further allows for a Vendor to more particularly satisfy Buyer need and further allow optimum pricing to be realized as a Vendor knows more explicit details of the Buyer's requirements. The validation of the Sales Lead by the Buyer further provides benefits to the Service Provider such that resources need not be expended by the Service Provider in ascertaining the veracity of the Sales Lead. Such validation may be accomplished via web-based interactions, including for example and without limitation, electronic mail, instant messaging, text messaging, or other suitable communication methodologies.

The Lead Source module 108 allows a user to anonymously add a Sales Lead to the system 100 or to view and/or modify active Sales Leads that have been previously entered. In order to maintain anonymity, at least one of a name, an address, an IP address, a phone number, a facsimile number, and an email related to the Lead Source is not revealed to any disparate party within the system 100. In addition, the Lead Source module 108 can allow a user to view account information such as Buyer ratings, a scorecard, personal information, and/or compensation earned for participation in the system 100. When entering a new Sales Lead, a user can provide basic information such as: a prospective Buyer name (e.g., company name if commercial or individual name if residential), a street address, a phone number and the good or service required. The basic information can be designated as Block A.

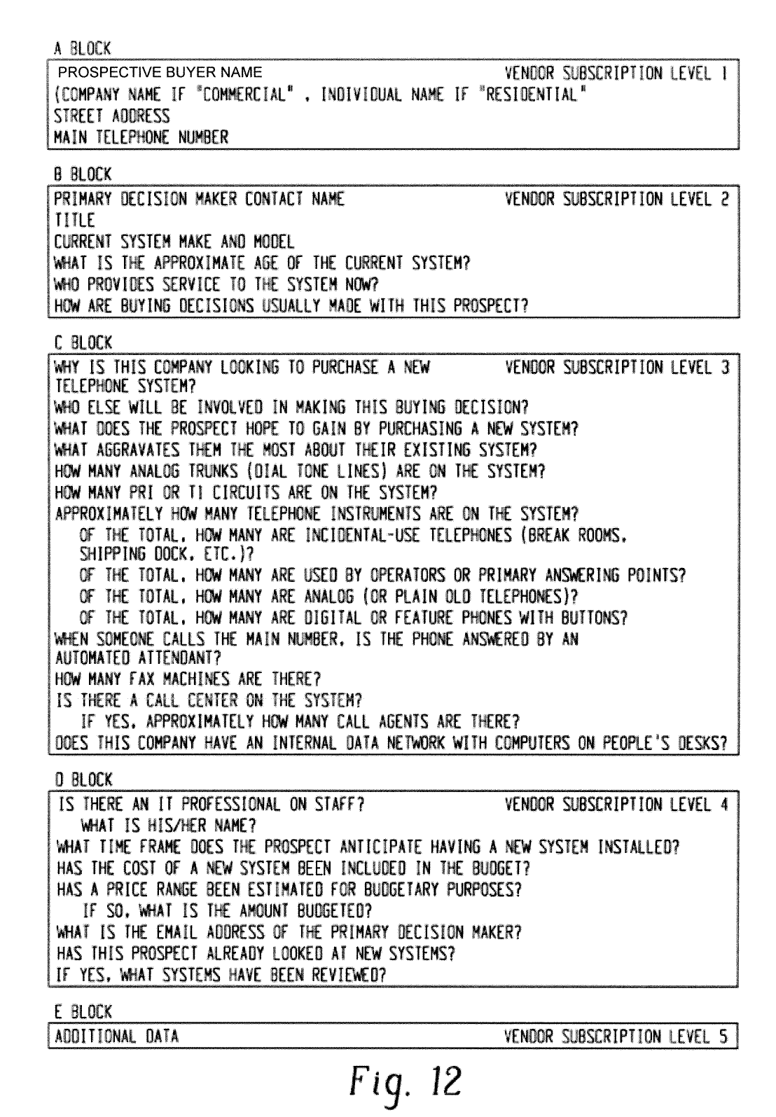

Additional information groupings that enhance Block A information can be designated as Block B, Block C, Block D, etc. These blocks can include a primary decision maker, a title, and a current make/model of a product, for example. In one embodiment, these blocks include the identity of the current Vendor of the product or service being reported as a new Project. If the current Vendor is also a subscribing member, the Service Provider may immediately contact this Vendor with information that their current customer is “Shopping” them. Suitable methods of contacting may include, for example and without limitation, electronic mail, SMS messaging, automated telephone contact, pop-up alerts, or the like. A tiered structure can allow information to be packaged into blocks available to access by disparate users. In one example, each information block is associated with a cost in addition to the basic information. It is to be appreciated that the information provided can vary from business to business or location to location. A form containing a plurality of information groupings for an exemplary business is provided herein at FIG. 12.

In order to create Sales Lead, a user need only enter information needed to satisfy block A. In turn, the system 100 can evaluate whether such information has been previously provided to the system 100 and notify the user of the same. Either the user or a system administrator can assign a category for the good/service required in each Sales Lead. In one example, the good required is an automobile and is placed into a vehicle category. The category structure is consistent for Lead Sources and Vendors to insure appropriate pairing of Lead Sources with Vendors. Thus any Vendors that are enrolled in the vehicle category and in the appropriate zone will receive an opportunity to purchase this Sales Lead.

A Project is created for access and review by the Lead Source, the appropriate Vendors and the prospective Buyer referenced in the Lead Source. Creation of a Project requires 1) block A information and 2) a category assigned thereto. Once a Project is created, an email or other communication can be provided to the Buyer specified in the Sales Lead (e.g., via the Buyer module 106) to invite them to participate in the sales process. The Buyer in turn can provide more specific details related to the job requirement such as: budget constraints, product preferences and information to provide optimum times/methods of contact.

Compensation paid to the Lead Source can vary at least in part upon the quantity and quality of the information provided.

One aspect of the Lead Source module 108 is to maintain the anonymity of the Lead Source of information for the Sales Lead. Thus, when third parties within the system 100 view the Sales Lead, the user associated therewith will not be displayed. The Sales Lead will contain only information related to the Buyer. By maintaining unidentified Lead Sources, users are encouraged to provide more detailed and candid information to the system 100. This is especially true in cases where the user is unauthorized to communicate information related to a potential sales event, wherein a Lead Source may not have authority to speak on behalf of a company to provide such information.

The Vendor module 110 lets a user register with the system 100 as a party that sells goods and/or services. The user can also specify one or more categories that relate to such goods and services. The Vendor module 110 can request information from the user to initialize an account with the system 100. This information can include a company name, a contact, a phone number, a facsimile number, a mailing address, an email address, etc. This information can be compared to existing member data to ascertain whether a new account should be created. If, for example, an account with an identical email address has been created previously, the Vendor module can send a message to the user to utilize the authentication component 124 to access the system 100. If the contact information does not exist in association with the system 100, the user can enter additional information, accept a member agreement, create an ID, etc. to facilitate creation of a new user account.

The Vendor module 110 requires that a user specify one or more zones from which to receive Sales Leads. The zones provide granulated information that is related to one or more parameters such as a geographic location (zip code, area code, time zone, state, county, etc.). In this manner, the Vendor can focus resources to accommodate a predetermined market segment of their choosing. The Vendor can also select zones that they have not yet entered to evaluate whether market entry is warranted in the future. The Vendor module 110 also allows a user to monitor current customers to insure they are satisfied with the goods and/or services they are receiving. A current Buyer (i.e., existing customer) listed in a Lead Source can be an indication that the Buyer is looking for an alternate source for such good and/or services, e.g., “Shopping” by the Buyer.

The general member module 112 is utilized to categorize a user to insure they interface with members of the system 100 to a maximum benefit. In one example, the general member module 112 invites a user to become one of a Lead Source, a Vendor or a Buyer in order to interact with other modules 106-110 and 114-116 of the system 100. If the user wishes to become a Lead Source, the system 100 can notify the user of the requirements related thereto. In one example, the user can be required to have particular payment methodologies, legal documents, tax documents, etc. in order to qualify as a Lead Source with the system 100. If the user wishes to become a Vendor, the system 100 can request information related thereto such as an employer ID number, a category related to goods and services sold, zones, contractual arrangements, etc. If the user wishes to become a Buyer, the system 100 can provide Lead Source and/or Vendor information to the Buyer in order to allow participation for a mutually beneficial relationship between the Buyer and the Vendor based upon the information provided by the Lead Source.

The advertiser module 114 allows advertisers to establish an account with the system 100 in order to display specific messaging that is relevant to Sales Leads, e.g., the interested Buyer and interested Vendors. In one example, the advertiser's messaging is displayed alongside the Vendor when viewed by a prospective Buyer. Such ad messaging can be related to goods and/or services that complement those provided by the Vendor to allow a Buyer to enhance or amend their requirements for a particular Sales Lead. According to another example embodiment, when a Validating Buyer views the Project corresponding to the Sales Lead for which the Buyer was contacted, the advertiser module 114 presents targeted advertisements relating to the specific goods/services identified in the Sales Lead and associated with the advertiser.

The manufacturer module 116 is utilized by manufacturers to monitor Lead Source information and/or product-related feedback from Buyers to enhance product quality and/or modify product offerings in the marketplace. In this manner, manufacturers can utilize information from members (e.g., Lead Sources and Buyers) in a particular market to more adequately serve the prospective Buyers therein. The manufacturer module 116 can allow a user to categorize and identify particular keywords and/or other metrics that are requested by Buyers or provided within a Lead Source. This information can be organized and packaged to serve as an accessible reference for the manufacturer.

The registration component 122 allows a user to create a new account for access to the system 100. The account information can be specific to a particular user type such as a Buyer, a Lead Source, a Vendor, an advertiser or a manufacturer. Specific information related to each user type can be entered into preset fields including an email address contact. Once this information is entered, the email address can be checked against email addresses associated with current members to determine if an account already exists with the same contact information. If it is determined that the email address already exists, a notification can be provided to the user and/or the user can be directed to log in using the current email address. In contrast if the email address is not found within the system 100, further information can be gathered from the user. In addition, a member agreement can be presented for acceptance by the user, a user can be created and saved to the system 100 to facilitate subsequent log in by the user.

The authentication component 124 is employed to access the system 100 via a previously created user ID and password. The authentication component can verify the user ID and password are valid and/or that the user ID exists within the system 100. Once the appropriate user name and password have been entered, the authentication component can allow a user to access information specific to their own account and/or to view information related to a Lead Source Vendor, etc. as appropriate. It is to be appreciated that additional verification techniques can be employed to maintain the security of the system 100 from unwanted users.

A computer 150 illustrates one possible hardware configuration to support the systems and methods described herein, including the system 100 above. It is to be appreciated that although a standalone architecture is illustrated, that any suitable computing environment can be employed in accordance with the present embodiments. For example, computing architectures including, but not limited to, stand alone, multiprocessor, distributed, client/server, minicomputer, mainframe, supercomputer, digital and analog can be employed in accordance with the present embodiment.

The computer 150 can include a processing unit (not shown), a system memory (not shown), and a system bus (not shown) that couples various system components including the system memory to the processing unit. The processing unit can be any of various commercially available processors. Dual microprocessors and other multi-processor architectures also can be used as the processing unit.

The system bus can be any of several types of bus structure including a memory bus or memory controller, a peripheral bus, and a local bus using any of a variety of commercially available bus architectures. The computer memory includes read only memory (ROM) and random access memory (RAM). A basic input/output system (BIOS), containing the basic routines that help to transfer information between elements within the computer, such as during start-up, is stored in ROM.

The computer 150 can further include a hard disk drive, a magnetic disk drive, e.g., to read from or write to a removable disk, and an optical disk drive, e.g., for reading a CD-ROM disk or to read from or write to other optical media. The computer 150 typically includes at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by the computer.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above can also be included within the scope of computer readable media.

A number of program modules may be stored in the drives and RAM, including an operating system, one or more application programs, other program modules, and program non-interrupt data. The operating system in the computer 150 can be any of a number of commercially available operating systems.

A user may enter commands and information into the computer through a keyboard (not shown) and a pointing device (not shown), such as a mouse. Other input devices (not shown) may include a microphone, an IR remote control, a joystick, a game pad, a satellite dish, a scanner, or the like. These and other input devices are often connected to the processing unit through a serial port interface (not shown) that is coupled to the system bus, but may be connected by other interfaces, such as a parallel port, a game port, a universal serial bus (“USB”), an IR interface, etc.

A monitor, or other type of display device, is also connected to the system bus via an interface, such as a video adapter (not shown). In addition to the monitor, a computer typically includes other peripheral output devices (not shown), such as speakers, printers etc. The monitor can be employed with the computer 150 to present data that is electronically received from one or more disparate sources. For example, the monitor can be an LCD, plasma, CRT, etc. type that presents data electronically. Alternatively or in addition, the monitor can display received data in a hard copy format such as a printer, facsimile, plotter etc. The monitor can present data in any color and can receive data from the computer 150 via any wireless or hard wire protocol and/or standard.

The computer 150 can operate in a networked environment, i.e., coupled to the network 152, using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

FIG. 1 further depicts a backend component associated with the Service Provider, illustrated as a server 154 in data communication with the computer 150 via the network 152. It will be appreciated that the server 154 is capable of implementing the exemplary method described below. The server 154 may include a computer server, workstation, personal computer, combination thereof, or any other computing device.

According to one example embodiment, the server 154 includes hardware, software, and/or any suitable combination thereof, configured to interact with an associated user, a networked device, networked storage, remote devices, or the like. The exemplary server 154 includes a processor 156, which performs the exemplary method by execution of processing instructions 160 which are stored in memory 158 connected to the processor 156, as well as controlling the overall operation of the server 154.

The server 154 may also include one or more interface devices for communicating with external devices. Such input/output interfaces may communicate with one or more display devices, for displaying information to users, such as location-related data, user input devices, such as a keyboard or touch or writable screen, for inputting text, and/or a cursor control device, such as mouse, trackball, or the like, for communicating user input information and command selections to the processor 156. The various components of the server 154 may be all connected by a data/control bus (not shown). The processor 156 of the server 154 is in communication with the associated database 162 via a communications link. A suitable communications link may include, for example, the public switched telephone network, a proprietary communications network, infrared, optical, or any other suitable wired or wireless data transmission communications. The database 162 is capable of implementation on components of the server 154, e.g., stored in local memory 158, e.g., on hard drives, virtual drives, or the like, or on remote memory accessible to the server 154.

The server 154 may be a general or specific purpose computer, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 158 may represent any type of non-transitory computer readable medium such as random access memory (RAM), read only memory (ROM), magnetic disk or tape, optical disk, flash memory, or holographic memory. In one embodiment, the memory 158 comprises a combination of random access memory and read only memory. In some embodiments, the processor 156 and memory 158 may be combined in a single chip. The one or more interface devices associated with the server 154 may include one or more network interfaces that allow the server 154 to communicate with other devices, e.g., the computer 150, via a computer network 152, and may comprise a modulator/demodulator (MODEM). Memory 158 may store data the processed in the method as well as the instructions for performing the exemplary method.

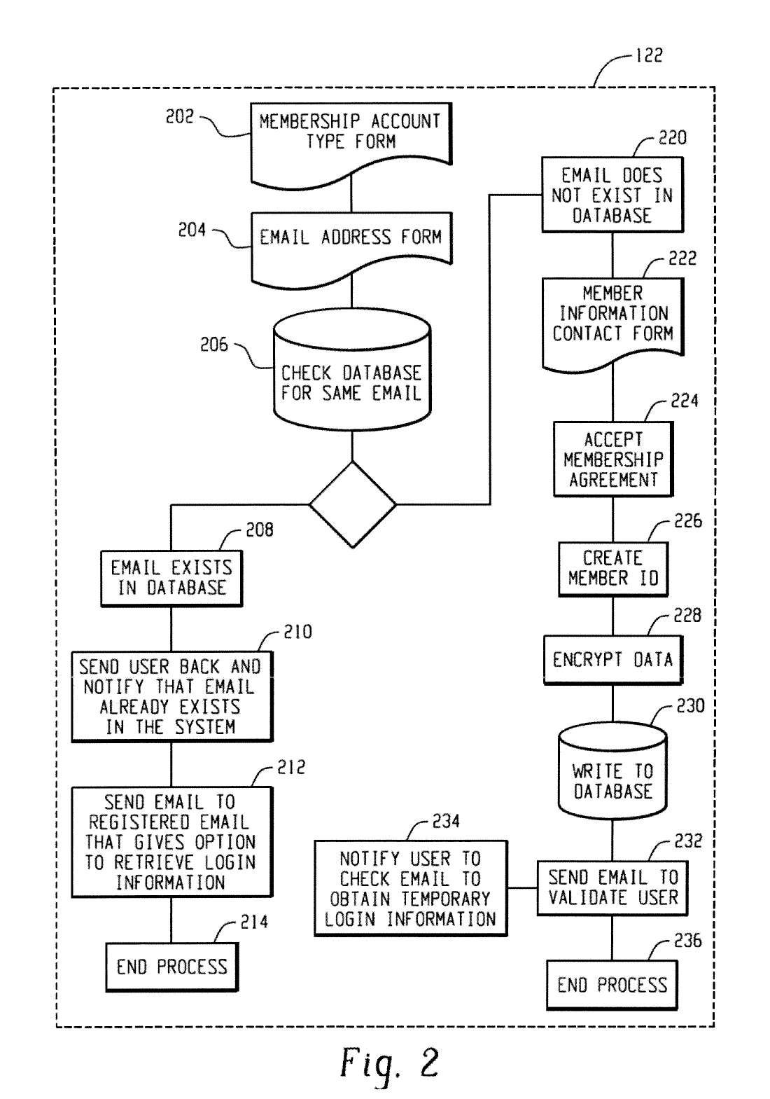

The central processing unit, i.e., the processor 156, can be variously embodied, such as by a single-core processor, a dual-core processor (or more generally by a multiple-core processor), a digital processor and cooperating math coprocessor, a digital controller, or the like. The processor 156, in addition to controlling the operation of the server 154, executes instructions stored in memory 158 for performing the method outlined in FIGS. 2-13, as set forth below.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions

In data communication with the server 154 is a database 162 comprising information/data relative to the system 100. In exemplary embodiments, the database 162 stores data associated with Buyers, Lead Sources, Vendors, membership information, advertiser information, manufacturer information, user account information, Sales Leads, Project information, and the like. It will be appreciated that while illustrated as separate components, the various modules, computers, servers, and databases depicted in FIG. 1 may be comprised in a single device, e.g., a server with connectivity to Buyers, Lead Sources, and Vendors that is operated by the Service Provider and partially accessible to such Buyers, Lead Sources, and Vendors via thin client interfaces, e.g., web browsers, or the like.

FIG. 2 illustrates the registration component 122. At 202, a membership account type form is presented to a user to gather information related to a particular membership account type. This information can include particular aspects of a user that relate to their role as a member of the system 100. In one example, the user requests membership as a Vendor. An employer ID number, a Vendor category and/or zones from which to receive lead information can be entered. At 204, a contact email address form is presented to the user to provide one or more email address contacts. At 206, a system 100 database is checked to determine if the email address entered at 204 has been previously entered. At 208, if the email address does exist in the database, a notification is sent to the user that such a condition exists at 210. At 212, an email is sent to the registered email address that allows a user to retrieve log information associated therewith in order to allow the user to access the system 100. At 214 the process ends.

At 220, if the email is not found in the database, a member information contact form is presented at 222. The member information contact form can request information related to the user such as their business name, address, position, etc. It is to be appreciated that the member information contact form can be associated with the member account type form presented at 202, wherein the information requested is particular to the user type. At 224, a membership agreement is presented to the user for acceptance to allow registration with the system 100.

At 226, the user creates a member ID of their choosing, wherein the parameters for ID selection can require specific characters and/or disallow specific characters. At 228, the data entered by the user is encrypted and, at 230, is written to a database. Once the encryption and writing process is complete, the user has successfully created a user ID to access the system 100. At 232, an email is sent to validate the account and, at 234, the user is notified to check the email to obtain temporary log in information. The temporary log in information can be modified once the user has utilized it to access the system 100. At 236, the process ends.

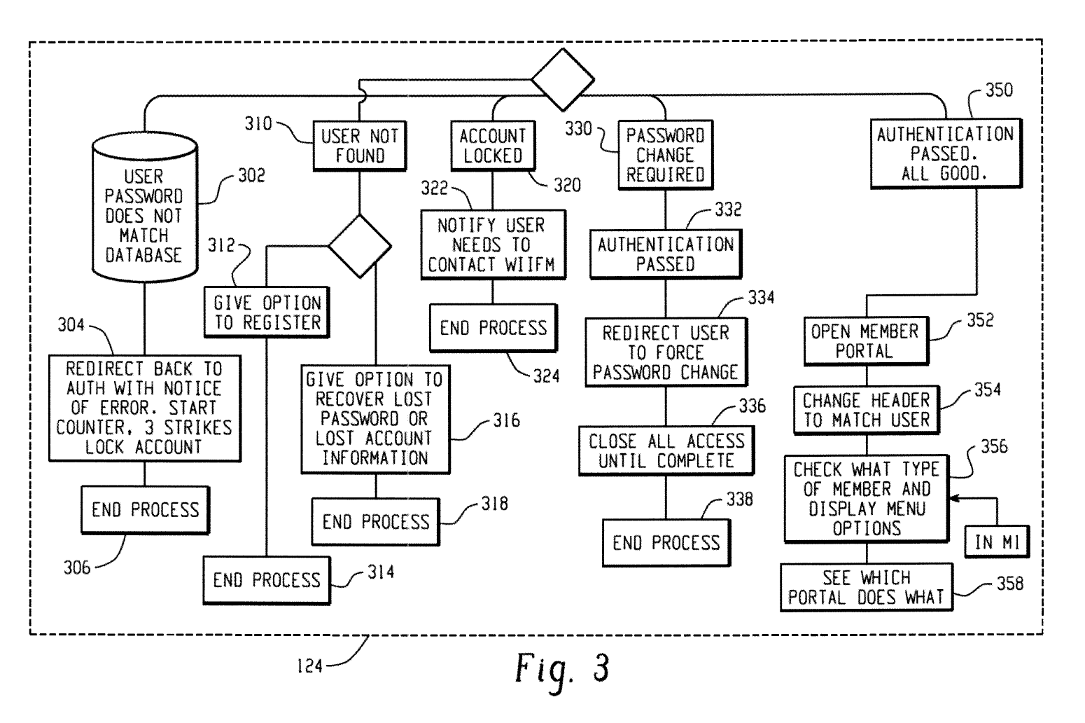

The authentication component 124, illustrated in FIG. 3, is utilized to authenticate users to access the system 100. At 302, once a user and password have been entered, they are verified with existing account information for all users. If the user and password do not match what is stored in the database, at 304, the user is redirected back to the authentication component 124 and a counter is started. The user then has the opportunity to enter their user identification and password two more times before the authentication component 124 locks out the account. At 306, the process ends.

In another scenario, at 310, a user ID is not found in the database. At 312, a user is given the option to register their account wherein the process ends at 314. In this scenario, the authentication component 124 can redirect the user to the registration component 122 to facilitate registration thereof. At 316, a user is given the option to recover a lost password or lost account information. In one aspect, the user can provide an email address, wherein information relating to authentication (e.g. user ID and/or password) is sent to the user for subsequent use to access the system 100. At 318, the process ends.

If the account is locked for whatever reason (e.g. a user ID has been entered incorrectly three times) at 320, a user is notified that they need to contact a system 100 administrator at 322. At 324 the process ends. A password change can be required by the user at 330 in some instances, such as when a predetermined condition is met. In one example, the predetermined condition is that irregular account access is observed such as access from a plurality of disparate IP addresses. Such access can signal fraudulent or unauthorized use of a particular account. At 332, once the user ID and password have been authenticated, the user is directed to change their password at 334. Until the password change is complete, at 336, all access to the system 100 is closed to the user. At 338 the process ends.

Once authentication has passed, the user can be directed to the system 100 at 350. At 352, a member portal (e.g. the entry portal 104) can be opened wherein access to the system 100 is facilitated. At 354, the appearance of the web interface 102 can be modified to match a user preference so that the presentation of data is consistent with a user preference. At 356, a user can check the type of member account that they are associated with and a display of menu options can be presented to the user. At 358, a user can evaluate information type and information a user may access if they open one or more disparate account types. In one example, the user can review a Lead Source module, a Vendor module, a general member module, etc. Such access can be consistent with the type of account that the user has activated.

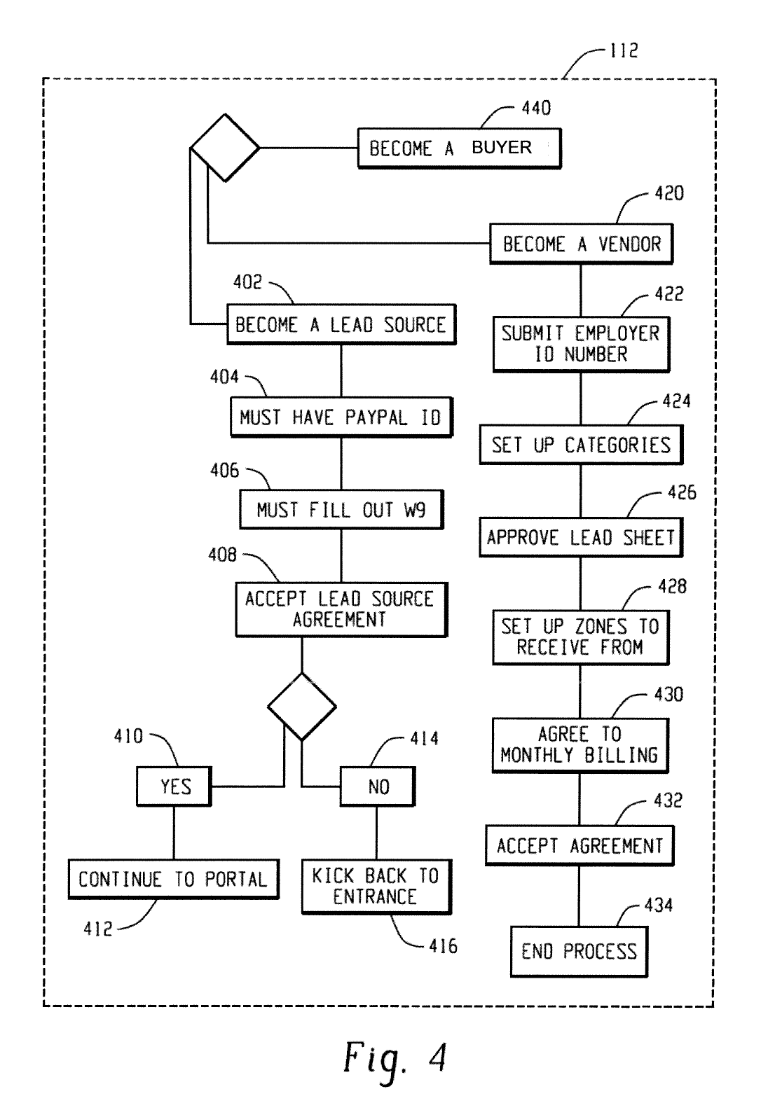

FIG. 4 illustrates the general member module 112 that allows a user to evaluate and select the various member types. For example, a user can evaluate membership opportunities as a Lead Source, a Vendor, and/or a Buyer. If a user decides to become a Lead Source, at 402, they are presented with a plurality of requirements to be accepted to the system 100 as a Lead Source member. At 404, the system 100 requests a pay pal ID from the user. At 406, the user must fill out a W-9 form to be utilized for tax purposes and, at 408, the user must accept a Lead Source agreement that outlines the terms and conditions of membership to the system 100. If the user accepts such terms, at 410, they are directed to the portal to the Lead Source module 108. If the user does not accept such terms, at 414, they are redirected back to the general number module 112 to evaluate the membership options once again.

If a user would like to join the system 100 as a Vendor member type at 420, they are required to submit a plurality of information associated therewith. At 422, the user is requested to submit an employer ID number which can be related to the state in which the business is incorporated or otherwise in business. At 424, the user can select one or more categories that are associated with the goods and/or services provided by the user that can be sold to one or more prospective Buyers within the system 100. In this manner, the user can select appropriate categories to insure that the appropriate lead information is directed to the user as a Vendor member. Once the categories are selected, at 426, a user approves a lead sheet that contains representative Sales Leads within the categories selected.

At 428, the user selects one or more zones to receive such leads that can relate to a predetermined geographic area, such as a zip code, an area code, a state, a county, etc. At 430, the user agrees to a monthly billing plan and, at 432, accepts an agreement that outlines the terms and conditions as a Vendor member of the system 100. At 434 the process ends. Another member type is a user may also select a Buyer member type at 440, which allows a user to participate in a sales process with one or more Vendors by providing additional detail associated with the job requirement and/or provide feedback for goods and/or services received from one or more Vendors.

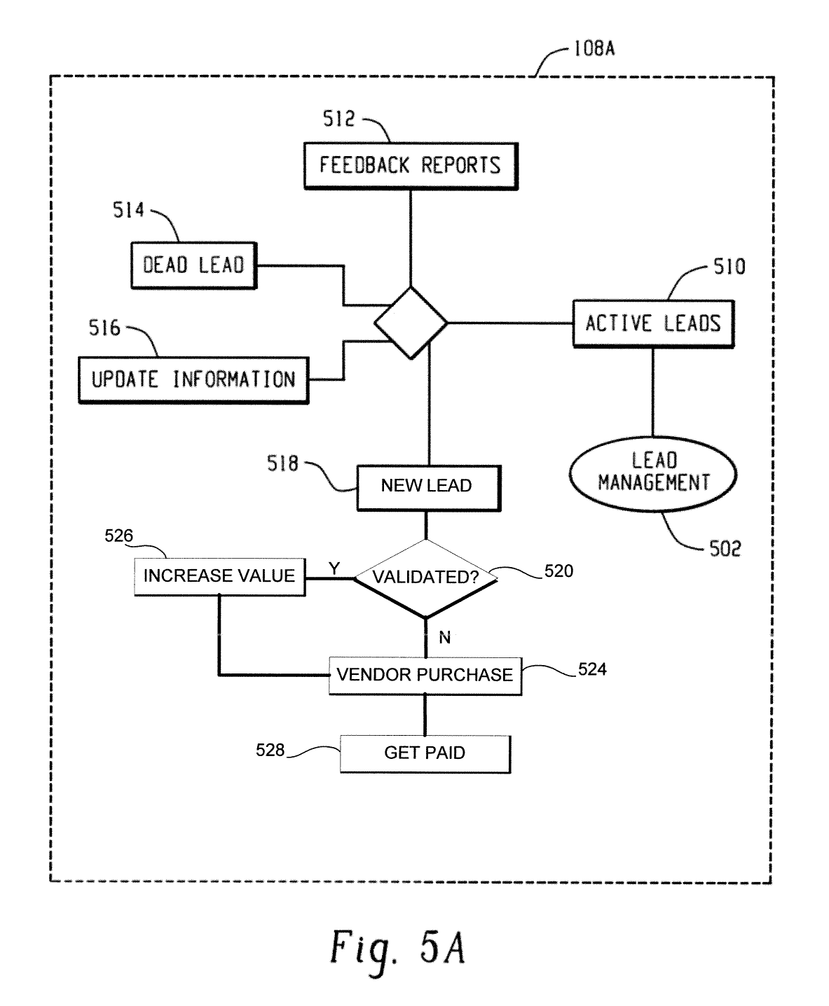

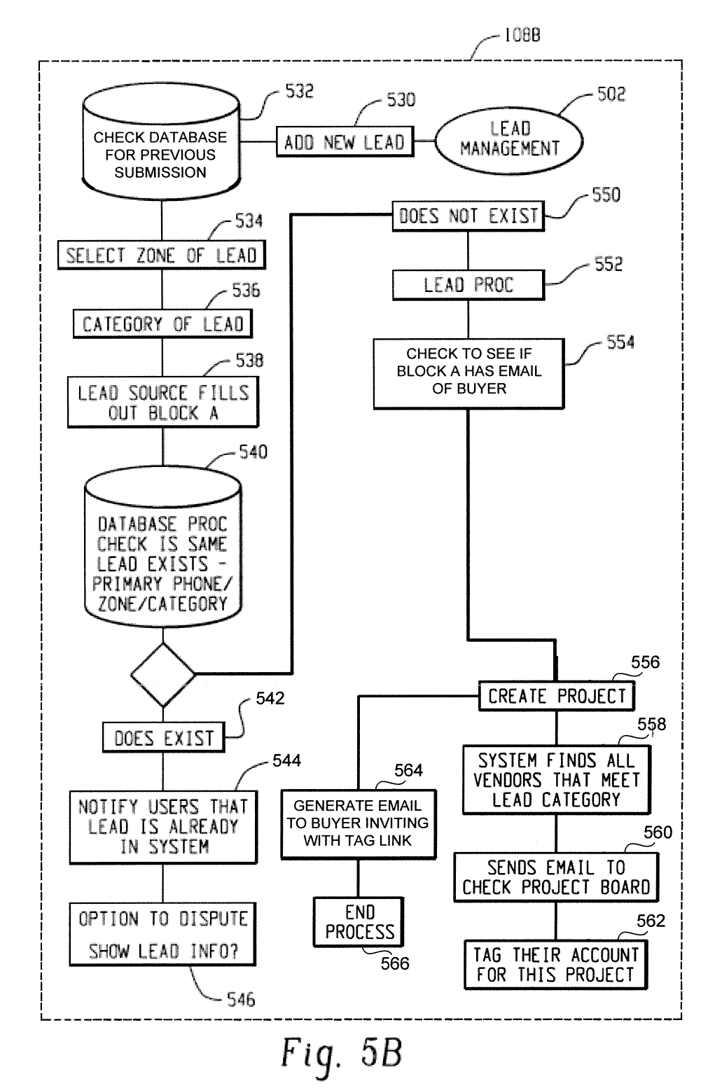

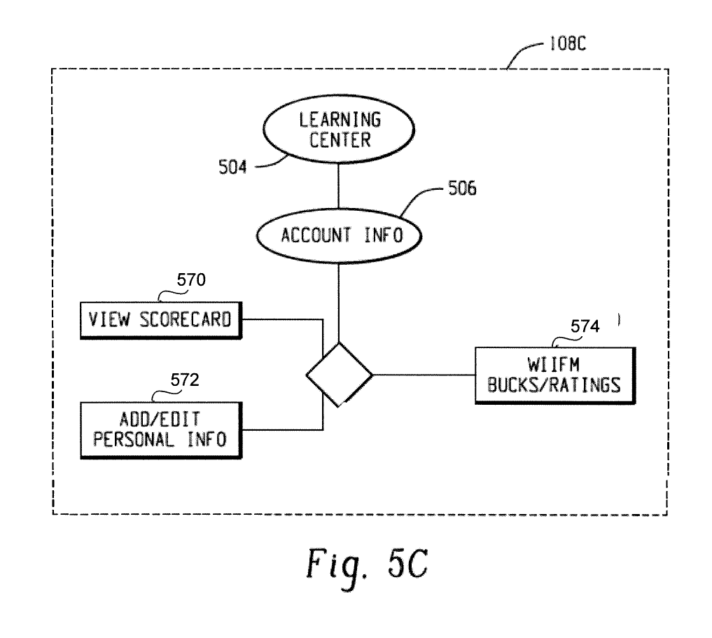

FIGS. 5A, 5B and 5C are directed to aspects 108a, 108b, and 108c respectively of the Lead Source module 108. In particular, FIG. 5A illustrates a lead management segment for the editing and review of active Sales Leads; FIG. 5B allows a user to add a new Sales Lead to the Lead Source module 108; and FIG. 5C allows a user to review information related to their specific account. Turning now to FIG. 5A, which allows a user to select an active Sales Lead at 510. The active Sales Lead can contain information previously entered that relates to one or more aspects of a potential sale to a Buyer.

Information can be updated for one or more active Sales Leads wherein a dead Sales Lead can be designated as such at 514 and an active Sales Lead can have information modified therein at 516. In this manner, any information associated with the Sales Lead within the system can be kept up to date such that Vendors and Buyers can facilitate transactions in an optimum environment.

At 518, a new Sales Lead may be added. At 520, a determination is made whether the Sales Lead has been validated by the Buyer. In the event that validation has occurred, the cost associated with the purchase of the Sales Lead is suitably increased at 526. After cost increase at 526, or when no validation occurs, the Vendor may purchase the Sales Lead at 524. According to one example embodiment, the cost of the Sales Lead may be related to the quantity of goods and/or services to be sold, the relative value of the goods and/or services, or a combination thereof. For example, the cost of a Sales Lead relating to a corporate jet will cost more than a Sales Lead relating to snow plowing service. The increase in value of the Sales Lead to the Vendor at 526 may be affected based upon additional information from the Buyer during validation, e.g., confirmation that a purchase is imminent, the costs associated with the goods/service, and the like. Within the lead management segment 108b of the Lead Source module 108, a new Sales Lead can be added by a user at 530. At 534, a zone is selected for the Sales Lead and, at 536, a category is selected. In this manner, the geographic location and type of Sales Lead can be ascertained and indexed for future use. At 538, the user fills out a block of information to further specify the Lead Source. The Lead Source information is compared to previously entered Lead Source information and a database, at 542, to determine if the information has been previously entered. At 542, if the information does exist, a user is notified that the Sales Lead is already in the system at 544. At 546, the user is given an option to dispute the redundancy of the information and can provide additional information to support the disparity between the current Lead Source and one or more disparate Lead Source previously provided.

At 550, if the Lead Source does not previously exist, the Sales Lead is processed at 552. At 554, a check is made to see if the information block contains the email of the customer specified. If it does, a Project is created at 556. The system 100 finds all Vendors that meet the category associated with the Sales Lead, at 558, and sends an email to check a Project board at 560. The Lead Source account is then tagged at 562 for this specific Project created. At 564, an email is generated to invite one or more users with a tag link at 564. At 566 the process ends.

FIG. 5C illustrates a learning center segment 504 and an account information segment 506 of the Lead Source module 108. The learning center segment 504 can provide information related to methods and practices of obtaining information sufficient to generate a Sales Lead and ways of obtaining such information. For the sake of the information provided to the system 100, the learning center 504 can encourage users to gather information from a plurality of disparate resources such as a work place, a home environment, a social environment, etc. to obtain information related to the needs of their friends and colleagues. In this manner, a user can be armed with information related to needs of several different persons or entities that can be employed to generate a plurality of Lead Sources.

At 506, a user can review account information associated with their Lead Source module 108. At 570, a user can view a scorecard that relates to the feedback received by one or more Vendors and/or one or more Buyers to provide scoring related to the quality of information provided. Such quality can relate to whether the appropriate contact person was provided, whether correct need and/or deadline was provided, etc. At 572, a user can review and/or edit personal information related to their Lead Source account. At 574, a reward system can be reviewed wherein a Lead Source is rewarded for providing particular information related to disparate Projects. Such rewards can be given based on the type of lead provided during a certain time period, etc.

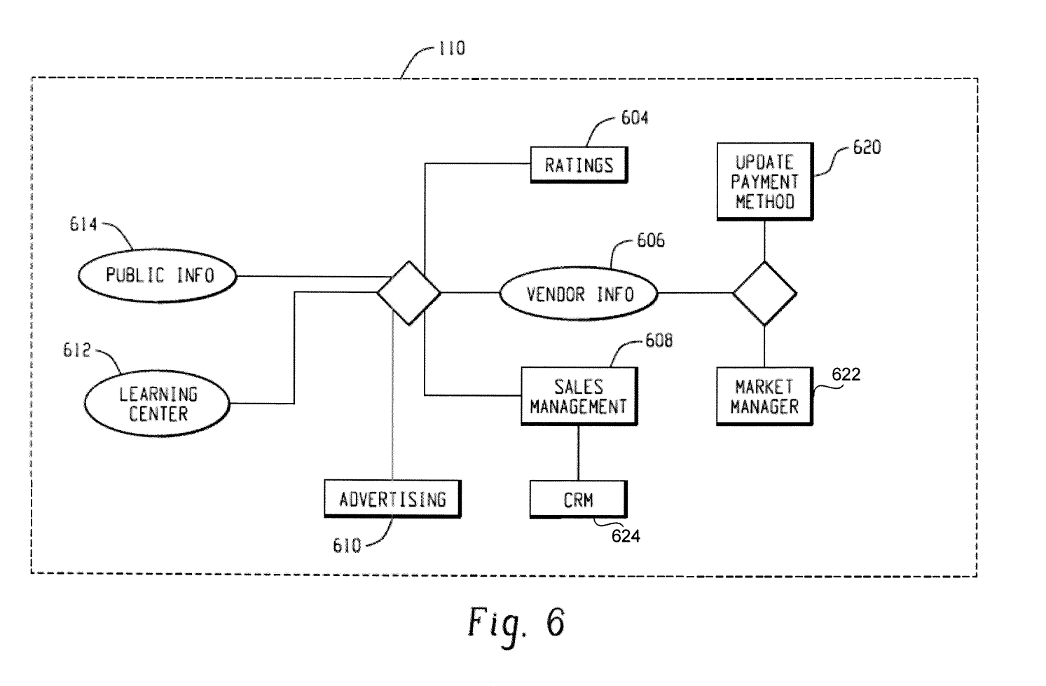

FIG. 6 illustrates the Vendor module 110 that allows a user to join the system 100 as a member selling goods or services. At 604, a user can review the ratings they have received from other members of the system 100. In accordance with one embodiment, Lead Sources may earn “bucks”, which are exclusively earned by Lead Sources to encourage generation of Sales Leads and correspond to a reward for the submittal of quality information and thus positive feedback from Vendors that utilized one or more Sales Leads provided by the Lead Source. In one example, the ratings relate to the quality of the goods and/or services provided to one or more Buyers or to the responsiveness to information provided by a Lead Source within the system 100. In another example, the Vendor can provide ratings to one or more Lead Sources.

At 606, Vendor information can be reviewed and edited. Such information can relate to the method of payment utilized at 620, and a market manager, at 622, that allows a Vendor to view activity in one or more markets in order to make informed decisions about resource allocation related to potential sales activities. At 608, a sales management tool can be utilized by the Vendor to ascertain the level of sales achieved through use of the system 100. At 624, a CRM tool can allow a Vendor to maintain appropriate levels of goods and services for customer relationship management. At 610 advertising can be introduced to coincide with goods or services provided by a Vendor.

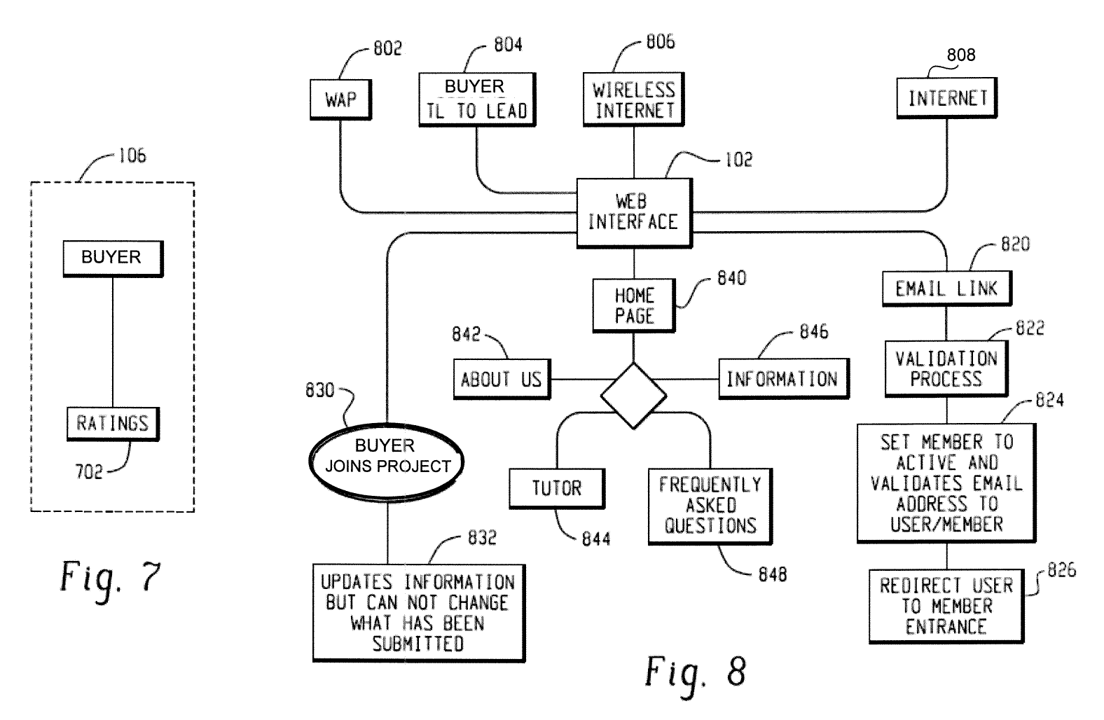

FIG. 7 illustrates the Buyer module 106. The Buyer module 106 permits a prospective Buyer to validate information contained within a Sales Lead, e.g., validate the information provided to the system 100 by a Lead Source, including, for example and without limitation, the imminent intent to purchase. The Buyer module 106 further includes a ratings module 702. The ratings module 702 allows a Buyer to provide feedback related to Vendors and/or the goods and services sold therefrom. In this manner, the Buyer can provide information available to prospective Buyers of the system 100 in order to facilitate informed decision making. The ratings can be stored in a common memory store for organization, access and review by others. Vendors can therefore be evaluated on more than price and delivery; they also must live with their reputation developed within the system 100. In this manner, Vendors that provide quality goods and/or services can be recognized as a “go to” resource to subsequent prospective Buyers.

FIG. 8 illustrates the web interface 102 of the system 100. As indicated, the web interface 102 can be accessed via a variety of means such as a WAP interface 802, a customer tag link to lead 804, a wireless Internet interface 806, or via an Internet interface at 808. The interfaces provided are for exemplary purposes only to provide sample means of communication with the web interface 102. It is to be appreciated that the website interface is maintained via the particular computer 150 for execution of code as needed to interact with users.

In addition to the above-referenced interfaces, an email link 820 can be utilized to access the web interface 102. The email link 820 can be emailed to one or more disparate members or non-members of the system 100 for access to the web interface by clicking on a link. In one example, the link is a URL that designates the web interface 102. Once the email link 820 is clicked, a validation process 822 can be utilized to verify that the member utilizing such link is valid. At 824 the member can be set to active and the email address can be validated to that specific member. At 826 the user is redirected to the member entrance within the web interface 102.

The web interface 102 can also include a plurality of information modules that allow a user or member to familiarize themselves with various aspects of the system 100. A home page entrance allows a user to access the various segments of the system 100 such as a Lead Source, a Vendor, a Buyer, etc. The home page 840 can contain a logo that designates the facilitator of the system 100 as well as various legal notices, contact information, etc. The about us segment 842 can include contact information, including the address and phone number of one or more offices, administrative staff, and leadership of the company of the business facilitating the system 100. The information 846 module can provide supplementary information to the about us module 842 related to the history of the company, markets served, etc.

A tutor module 844 can be utilized by a user to learn about the different aspects of the system 100. In particular, the tutor module 844 can show an exemplary sales event that is facilitated by the presentation of a Lead Source within a particular category, the presentation of proposals from one or more Vendors to a Buyer specified by the Lead Source, and the facilitation of an ultimate sales event between the Vendor and the customer referred within the Lead Source.

An FAQ module 848 can provide a knowledge base of information gathered from questions asked by users in the past. The FAQ module 848 can allow a user to review answers to questions that may be similar to their own prior to contacting support personnel. In this manner the user can received satisfactory support in a timely manner by quickly reviewing answers to questions that are frequently asked. At 830, a Buyer can join a Project and communicate with the web interface 102. The Buyer is able to update information, at 832, provided in a Sales Lead but cannot change what has been previously disseminated by the Lead Source.

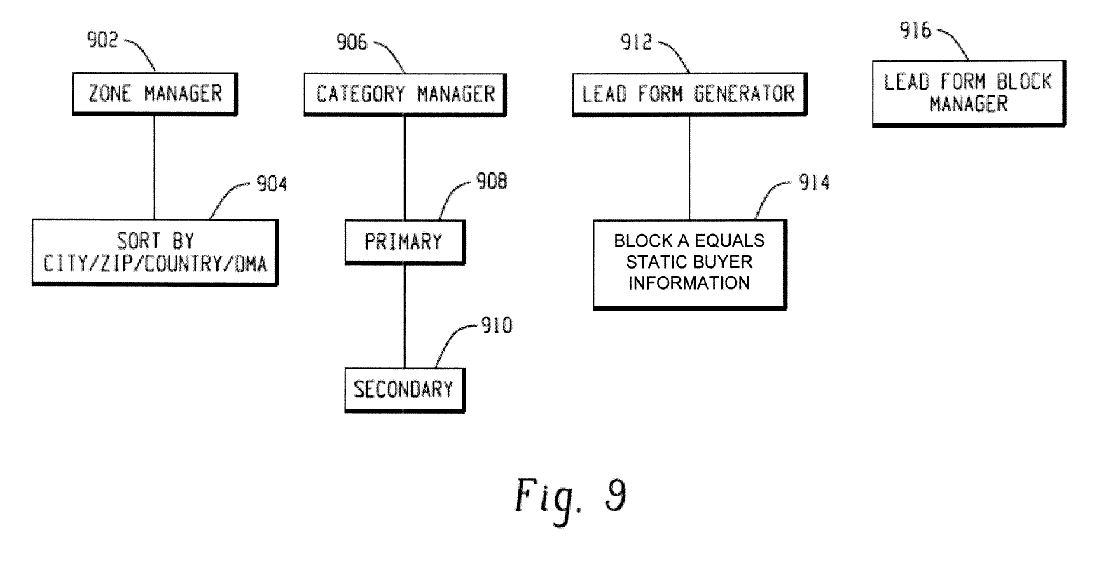

FIG. 9 illustrates additional administrative tools available within the system 100. A zone manager 902 can allow zones to be specified in substantially any granular form. For example each zone can relate to a particular geographic location such as a zip code, an area code, a county, a state, etc. Alternatively, or in addition, zones can be specified by types of goods/services of one or more of the above and/or related to specific locations associated with a particular industry. In this manner, the system 100 can provide zones to users that are relevant and up to date.

A category manager 906 allows disparate categories to be created that are related to particular areas of business. A one or more primary categories can be specified at 908 wherein each of the primary categories is associated with one or more secondary categories at 910. It is to be appreciated that a plurality of levels of categories can be specified beyond a secondary level. Each category can be specific to a particular industry, business type, or related to goods or services sold. The category manager 906 allows categories to be added as needed when disparate business interests are generated by the members of the system 100.

Elite form generator 912 allows information provided by a Buyer to generate into a Sales Lead via the Lead Source module. At 914, a block of information provided by the Buyer is mapped to one or more fields in a Lead Source for use and review by one or more Vendors as appropriate. The Lead Form generator 912 allows a Buyer to realize Sales Lead purchase fees by all Vendors purchasing a particular lead as submitted by the Buyer, thus effectively reducing the price of their purchase. A Lead Form block manager 916 can allow the fields for a Lead Form to be modified to request specific information related to the goods and/or services associated with the Sales Lead, and the like.

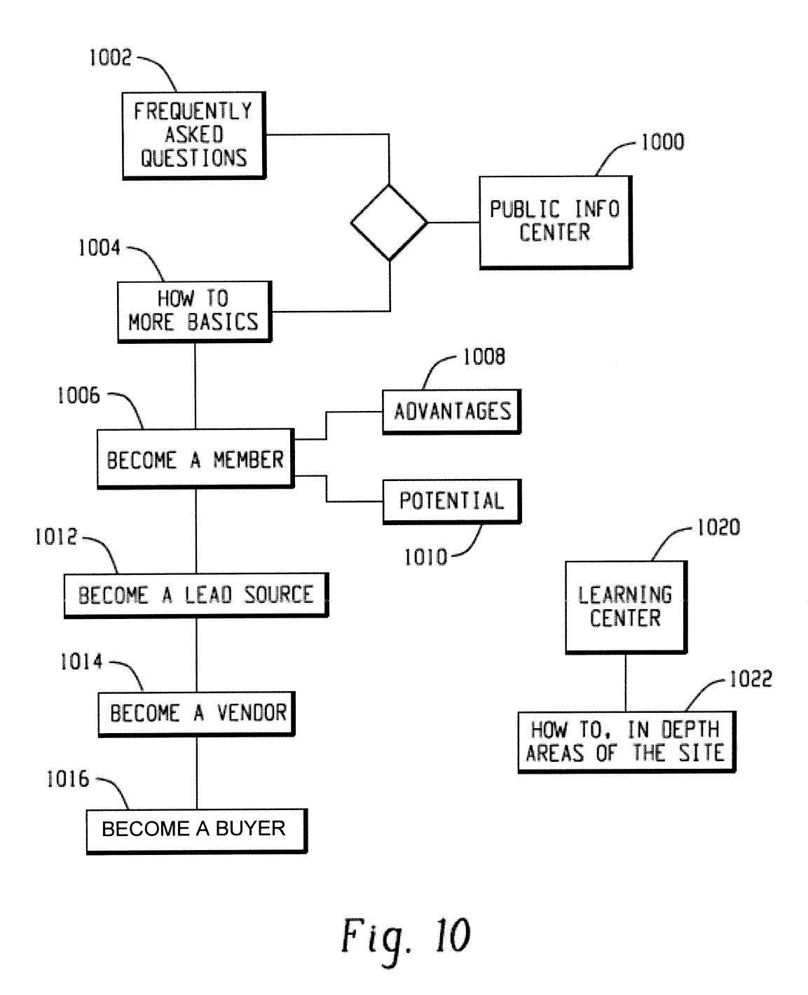

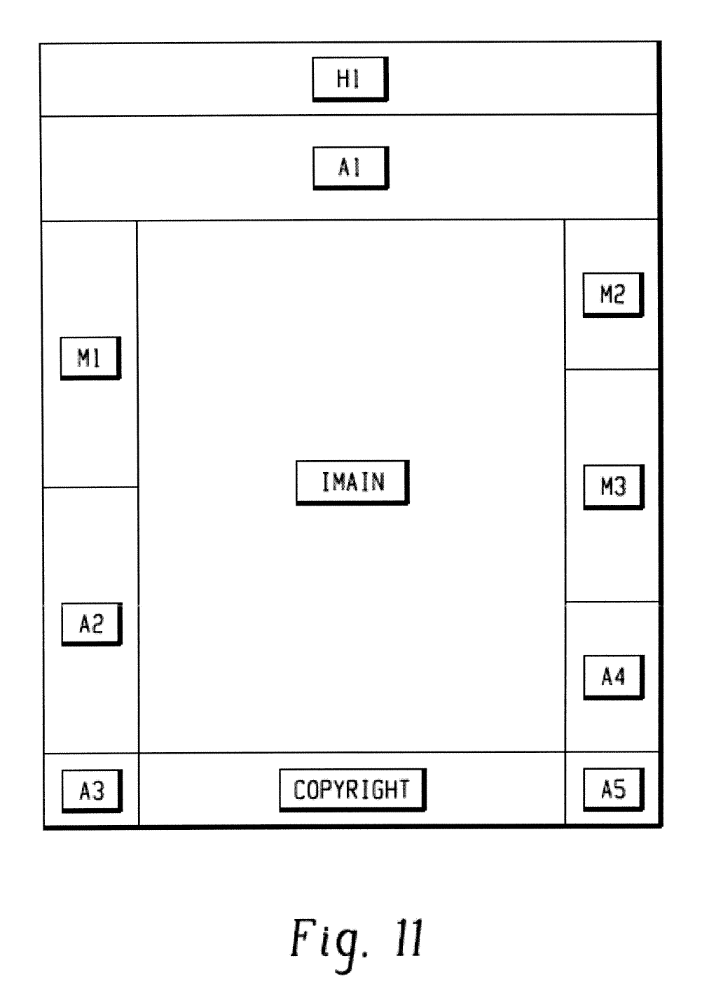

FIG. 10 illustrates a public information center and a learning center. A public information center 1000 is related to frequently asked questions module 1002 and a how to more basics module 1004 in addition to the tutor module 844 and the FAQ module 848. A user can discern how to become a member at 1006 and the advantages at 1008 and potential income realized at 1010 associated therewith. At 1012, a user can learn how to become a Lead Source and how to become a Vendor at 1014 and a Buyer at 1016. By providing this information to potential members, users can reap the full benefit of the use of the system 100. The learning center 1020 allows administrators to edit the content associated with information provided to users that interface with the system 100. At 1022 a module can be utilized to utilize and expound on various aspects of the information provided to users visiting the web interface 102.

FIG. 11 illustrates an exemplary web interface 102 that can contain a plurality of fields in particular locations. A header H1 can contain a logo or other information related to the system owner or facilitator. Areas A1, A2, A3, A4 and A5 designate exemplary locations for advertising space within the web interface 102. Areas M1, M2, and M3 designate displays that are member specific. That is, they relate to a member type and information associated therewith. !MAIN displays content provided by the system 100 to the web interface 102.

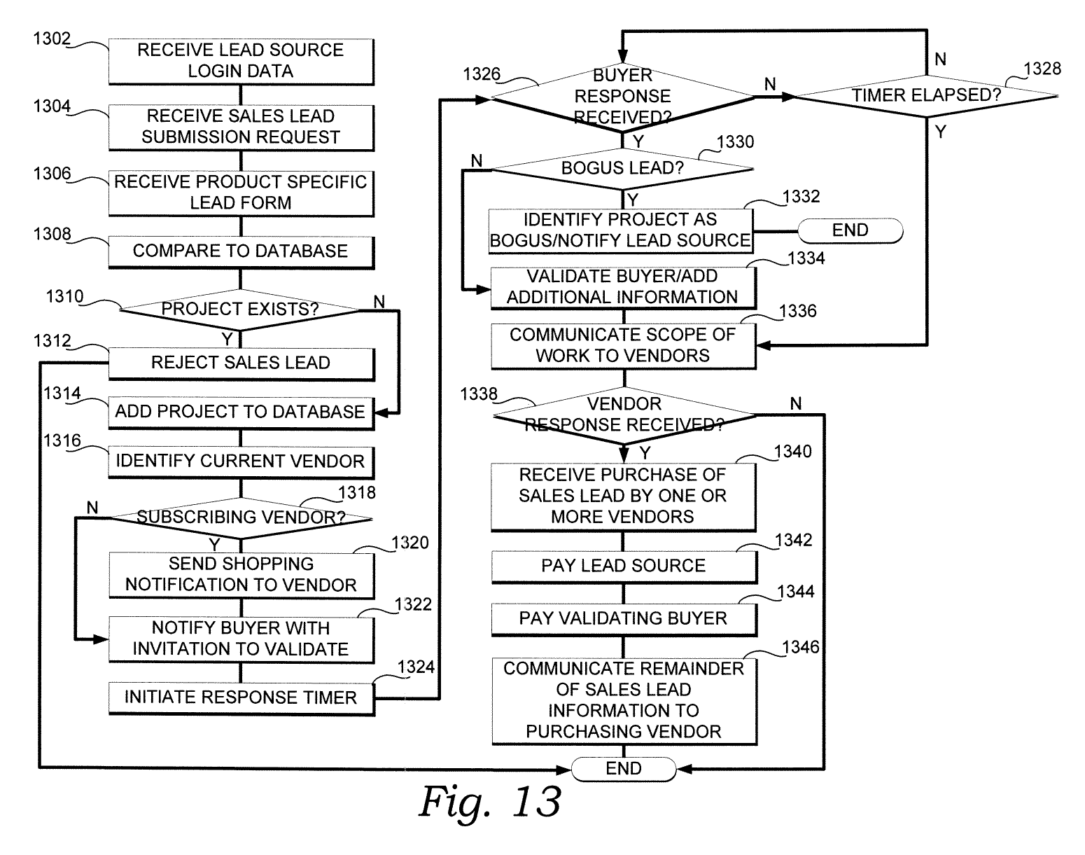

FIG. 13 illustrates an exemplary methodology 1200 depicting varying implementations of embodiments described above. At 1302, login data is received from the Lead Source by the Service Provider, e.g., via the server 154. It will be appreciated that the login data may comprise a username, password, or other registration information, as set forth above, so as to identify the Lead Source. At 1304, the server 154 or other suitable component of the system 100 receives a Sales Lead submission request, e.g., information related to a Buyer, contact information, identification of the current Vendor, timeframe for purchase, identification of the goods/services, etc. A product specific lead form, i.e., the Lead Form, is suitably completed by the Lead Source and received by the server 154 or other suitable component of the system 100 at 1306. In accordance with the embodiments discussed herein, the Lead Form may be completed via web-based interactions facilitated via the computer 150, the server 154, and the corresponding modules 106-116, as referenced in greater detail above. In such embodiments, the Lead Source may be presented with product/service categories, e.g., “Business Telephone Systems,” “Office Furniture,” “Legal Services,” “Lawn Care,”, or the like. The selection of one such category prompts the product/service specific Lead Form to be completed by the Lead Source at 1306.

According to one embodiment, the Lead Form may include the Buyer name and address, Buyer telephone number and Decision Maker identification, Buyer email address of contact person, Buyer's Current Vendor, and a Scope of Work (a set of specific questions providing general Project description and information for the purchase, including, for example and without limitation quantity/description of specific need, timeframe to purchase, amount budgeted, reason for purchase, etc. The Lead Form may further inquire of the Lead Source whether the Lead Source desires to Anonymously submit the Sales Lead, or allows his/her identity to be shared with Vendors purchasing the Sales Lead. The Lead Form may also require that the Lead Source verify the veracity of the content submitted, including an acknowledgement as to the repercussions of submitting Bogus Sales Leads.

The server 154 then compares the information received in the Lead Form to Project data stored in the database 162 at 1308 so as to determine at 1310 whether a Project corresponding to the information contained in the Lead Form has already been submitted. Upon a positive determination at 1310, operations proceed to 1312, whereupon the Sales Lead is rejected and the methodology 1300 of FIG. 13 terminates. That is, the information contained in the Lead Form, e.g., the Buyer, the goods/services, etc., are compared to Projects stored in the database 162. Thus, when an existing Project is located in the database 162, the Sales Lead is rejected and the Lead Source may be notified of the rejection.

Upon a determination at 1310 that a Project does not exist which corresponds to the information associated with the Lead Form submitted by the Lead Source, operations proceed to 1314, whereupon a Project is created and added to the database 162 corresponding to the Sales Lead. According to one embodiment, when the Project does not exist in the database 162, the Lead Source is informed that this lead is officially registered to them and they are in line to receive any financial reward relative to the Vendor purchase of this information.

The Current Vendor, if so identified in the Lead Form, is then identified at 1316. That is, the server 154 or other suitable component (hardware/software) associated with the system 100 identifies the Current Vendor named on the Lead Form submitted by the Lead Source that is currently providing the goods/services to the Buyer. The identified Current Vendor is then compared to subscribing Vendors in the database 162 so as to determine, at 1318, whether the Current Vendor is a subscribing member with the Service Provider, as discussed above.

In the event that the Current Vendor is identified by the system 100 as a member subscribing with the Service Provider at 1318, a notification that a current customer (the Buyer) of the Vendor is seeking competitive quotes, also known as “Shopping,” is sent to the Current Vendor. The various benefits to the Current Vendor associated with the Shopping notification are referenced in greater detail above, and include, for example and without limitation, the ability of the Vendor to immediately contact the Buyer so as remedy and perceived or actual issues that are leading the Buyer to Shop for a new Vendor. In accordance with one embodiment, the Shopping notification may be communicated to the Vendor via email, text message, automated voice communications, or other selected communications mediums, as will be appreciated. After communication of the Shopping notification at 1320, or upon a determination the Current Vendor is not a subscribing member with the Service Provider, operations proceed to 1322, whereupon a notification is communicated to the Buyer identified in the Lead Form by the Lead Source inviting the Buyer to validate the Sales Lead. As discussed in greater detail above, validation by the Buyer provides an increase in value to the Sales Lead, as Vendors are able to know prior to initiating contact with the Buyer that the Buyer is interested in the imminent purchase goods/services.

After notification to the Buyer at 1322, a Buyer response timer is initiated at 1324. According to one embodiment, the Buyer response timer is preselected to limit the amount of time that a Buyer has to validate the Sales Lead, so as to prevent the Sales Lead from growing cold before Vendors are notified of the opportunity. In such embodiments, the timer may be set to a predetermined number of hours, days, or the like. A determination is then made at 1326 by the server 154 or other suitable component associated with the system 110, e.g., the modules 106-116, whether a response has been received from the Buyer. In the event that no response has been received, operations proceed to 1328, whereupon the server 154 determines whether the timer has elapsed. If the timer has elapsed, operations proceed to 1336, as discussed in greater detail below. If the timer has not yet elapsed, operations return to 1326 until either timer has elapsed or a response is received from the Buyer.

Once a response is received, a determination is made whether the Sales Lead is a Bogus Lead at 1330. That is, if the response received from the Buyer indicates that some or all of the information submitted by the Lead Source is incorrect, no longer relevant, or the like, the Project associated with the Sales Lead is identified in the database 162 as Bogus and the Lead Source may be subject to sanctions, suspensions, forfeiture of proceeds, or expulsion from membership with the Service Provider at 1332. It will further be appreciated that while illustrated as responsive to information from the Buyer that the Sales Lead is a Bogus Lead, such information may be received from Vendors after the purchase thereof (as set forth below), wherein the Vendor contacts the Buyer and determines such Sales Lead is incorrect, irrelevant or false. In the event that the response received from the Buyer indicates that the Sales Lead is not a Bogus Lead, operations proceed to 1334, whereupon the Buyer may validate and optionally provide additional information with respect to the Project. Accordingly, the Buyer may provide additional information during the validation process relating to the Sales Lead, identifies a Decision Maker, Decision Influencer, quantities of goods/service desired, and the like. It will be appreciated that the Validating Buyer at 1334 may increase the cost to the Vendor associated with purchasing the Sales Lead.

According to one embodiment, the Service Provider may offer incentives to the Buyer if the Buyer agrees to validate the Sales Lead and provide additional information relative to their imminent purchase. When the Buyer agrees to validate the Sales Lead, the Buyer is suitably informed as to the Vendors who purchase the Sales Lead from the Service Provider. The Service Provider may further provide background information as to such Vendors likely to contact the Buyer to the Buyer, as well as any additional Vendor/Product Satisfaction information available to the Service Provider, white papers, manufacturer information, and other information designed to assist the Buyer in making informed buying decisions. In such embodiments, the database 162 associated with the Service Provider may store such information for ready dissemination to Validating Buyers.

According to one embodiment, upon receipt of the validated information from the Buyer, the “Scope of Work” portion of each Sales Lead, which may have been Anonymously reported and subsequently validated by the Validating Buyer, is sent to Vendors who have requested to review for possible purchase, these Sales Leads from specific zip codes corresponding with their sales territory. It will be appreciated that Sales Leads may be priced lower if the Buyer has not validated the information and higher if they have.

After validation at 1334, or upon a determination at 1328 that the timer has elapsed prior to receipt of a response from the Buyer, operations with respect to FIG. 13 progress to 1336, whereupon the server 154, the modules 106-116, or other suitable component associated with the system 100 communicate the Scope of Work associated with the Sales Lead to Vendors associated with the goods/services of the Project. It will be appreciated that the database 162 may store Vendor information and corresponding goods/services supplied by such Vendors, enabling easy identification of suitable Vendors for querying for purchase of the Sales Lead, as well as more quickly target only those Vendors that are capable of fulfilling the Scope of Work. As described in greater detail above, the Scope of Work includes Project-related information that enables a Vendor to determine whether or not to purchase the Sales Lead. The content of the Scope of Work may be selectively limited by the Service Provider as an incentive to the Vendor to purchase the corresponding Sales Lead.

After receiving the Scope of Work, Vendors decide whether the Sales Lead is an opportunity they wish to pursue and then purchase the Sales Lead (as discussed below), whereupon the remainder of the information on the Lead Form is revealed for their use. Vendors are then empowered to contact the Buyer and vie for the sale of that product or service.

A determination may then be made at 1338 whether a response has been received by the server 154 or other suitable component associated with the system 100 indicating one or more Vendors are interested in purchasing the Sales Lead based upon the Scope of Work. When no response is received, operations with respect to FIG. 13 terminate. It will be appreciated that the Service Provider may, for a predetermined time, maintain the Project in the database 162 and periodically resend the Scope of Work to identified Vendors.

When at least one Vendor response has been received, operations progress to 1340, whereupon the purchase of the Sales Lead is received from one or more Vendors responsive to the communicated Scope of Work. According to one embodiment, as each Vendor purchases the Sales Lead, their identity is simultaneously made known to the Buyer, together with available background information about them, the company they represent, and any other useful data that would assist the Buyer in becoming a more informed Buyer. Simultaneously with the Vendor's purchase of the Sales Lead, promotional items and other product-specific information may be sent to the Buyer, as approved by the Vendors.

At 1342, payment may be made to the Lead Source. That is, money received from Vendors for the purchase of Sales Leads may be paid to corresponding Lead Sources at 1342. It will be appreciated that such a process motivates Lead Sources to continue reporting active Sales Leads for all products and services. At 1344, payment may be made to a Validating Buyer (if any). That is, money received from Vendors for the purchase of Sales Leads may also be paid to Validating Buyers. This process also motivates Buyers to validate information associated with the Sales Leads as reported, thus producing “perfect” sales leads for subscribing Vendors. It should be noted that the payment to the Lead Source and the Validating Buyer need not be dependent upon the successful conclusion of a sales transaction between the Vendor and the Buyer, but may be made in response to the purchase of the Sales Lead by the Vendor, independent of the successful conclusion of such a sales transaction. The Service Provider, via the server 154, then communicates the remainder of the Sales Lead information to the Vendor at 1346.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for collecting and processing sales referral information, comprising:
a processor with access to associated memory, the associated memory storing an associated database comprising vendor information corresponding to a plurality of vendors, lead source information, sales lead information corresponding to a plurality of projects, and buyer information; and
memory in communication with the processor, which stores instructions which are executed by the processor for:
receiving sales lead information corresponding to an imminent purchase of a good or a service from a lead source, the sales lead information including an identity of a corresponding buyer, an identification of at least one of a good and a service, a scope of work, and an identification of a current vendor associated with the identified at least one good or service;
comparing the received sales lead information to sales lead information corresponding to the plurality of projects stored in the associated database;
comparing the identification of the current vendor to plurality of vendors stored in the associated database so as to identify a match therebetween in response to a result of the sales lead information comparison;
notifying an identified matching vendor of the received sales lead information in accordance with a result of the comparison of the current vendor;
communicating a portion of the sales lead information to at least one of the plurality of vendors, the portion of the sales lead information comprising the scope of work;
receiving, in response to the communicated portion of the sales lead information, a purchase of the sales lead information from at least one vendor of the plurality thereof; and
communicating a remaining portion of the sales lead information to the at least one vendor of the plurality thereof in response to the received purchase request.

2. The system of claim 1, wherein the memory further includes instructions executed by the processor for:
prompting the buyer for validation of the sales lead information received from the lead source; and
receiving a response from the buyer corresponding to the sales lead information.

3. The system of claim 2, wherein the memory further includes instructions executed by the processor for:
calculating a value associated with the sales lead information responsive to the response from the buyer indicating validation thereof; and
receiving the purchase request in accordance with the calculated value of the validated sales lead information.

4. The system of claim 3, wherein the memory further includes instructions executed by the processor for calculating a payment due the buyer associated with the sales lead information in response to the purchase thereof by the at least one vendor.

5. The system of claim 2, wherein the response from the buyer comprises bogus lead information, the memory further including instructions executed by the processor for identifying the sales lead information as bogus lead information in the associated database.

6. The system of claim 2, wherein the response from the buyer validating the sales lead information further includes additional sales lead information, the memory further including instructions executed by the processor for updating the stored sales lead information in accordance with the response received from the buyer.

7. The system of claim 1, wherein the memory further includes instructions executed by the processor for calculating a payment due the lead source in response to the purchase of the sales lead information by the at least one vendor.

8. The system of claim 1, wherein the associated database further stores information corresponding to each of the plurality of vendors and the goods or services associated therewith.

9. The system of claim 8, wherein the memory further includes instructions executed by the processor for:
determining at least one vendor from the plurality thereof in accordance with the identified goods or services of the received sales lead information; and
communicating vendor information associated with the determined at least one vendor to the buyer.

10. The system of claim 8, wherein the communicating a portion of the sales lead information to at least one of the plurality of vendors, further includes determining the at least one of the plurality of vendors in accordance with stored vendor information corresponding to a geographic location associated with the vendor and a geographic location associated with the buyer.

11. The system of claim 1, wherein the memory further includes instructions executed by the processor for storing a project corresponding to the received sales lead information in the associated database responsive to a result of the comparison with stored sales lead information indicating the received sales lead information is a new project.

12. The system of claim 1, further comprising a web-based interface, wherein the sales lead information is received by the processor via the web-based interface over an associated computer network, and wherein communication with at least one of the vendor and the buyer is via the web-based interface.

13. A method for collecting and processing sales referral information, comprising:
with a processor, collecting vendor information corresponding to a plurality of vendors, lead source information, sales lead information corresponding to a plurality of projects, and buyer information;
storing the collected information in an associated database in communication with the processor;
receiving sales lead information corresponding to an imminent purchase of a good or a service from a lead source;
verifying, with the processor, the received sales lead information is representative of a new project in accordance with a comparison of the received sales lead information to sales lead information corresponding to the plurality of projects stored in the associated database;
storing the verified received sales lead information as a new project in the associated database;
receiving a response from the buyer corresponding to the sales lead information indicating at least one of a valid or a bogus sales lead information;
communicating a portion of the sales lead information to at ^{If} one of the plurality of vendors responsive to a response from the buyer indicating valid sales lead information, the portion of the sales lead information comprising the scope of work;
receiving, in response to the communicated portion of the sales lead information, a purchase of the sales lead information from at least one vendor of the plurality thereof; and
communicating a remaining portion of the sales lead information to the at least one vendor of the plurality thereof in response to the received purchase request.

14. The method of claim 13, wherein the sales lead information includes an identity of a corresponding buyer, an identification of at least one of a good or a service, a scope of work, and an identification of a current vendor associated with the identified at least one good or service.

15. The method of claim 14, further comprising:
comparing the identification of the current vendor to plurality of vendors stored in the associated database so as to identify a match therebetween in response to a result of the sales lead information comparison; and
notifying an identified matching vendor of the received sales lead information in accordance with a result of the comparison of the current vendor.

16. The method of claim 14, further comprising modifying a value associated with the sales lead information in accordance with a response from the buyer indicating validation of the sales lead information, wherein the purchase of the sales lead information by the at least one vendor is in accordance with the modified value.

17. The method of claim 16, further comprising calculating a payment due at least one of the buyer and the lead source associated with the sales lead information in response to the purchase thereof by the at least one vendor.

18. The method of claim 14, further comprising updating the stored received sales lead information in the associated database in accordance with a response from the buyer indicating the sales lead information is bogus.

19. The method of claim 14, further comprising:
receiving a response from the vendor corresponding to the sales lead information indicating at least one of a valid or a bogus sales lead information; and
updating the stored received sales lead information in the associated database in accordance with the response from the vendor.

20. The method of claim 14, further comprising:
receiving in the response from the buyer validating the sales lead information additional sales lead information; and
updating the stored sales lead information in accordance with the response received from the buyer.

21. The method of claim 14, further comprising:
storing, in the associated database, information corresponding to each of the plurality of vendors and the goods or services associated therewith;
determining at least one vendor from the plurality thereof in accordance with the identified goods or services of the received sales lead information; and
communicating vendor information associated with the determined at least one vendor to the buyer.

22. The method of claim 14, wherein the communicating a portion of the sales lead information to at least one of the plurality of vendors, further includes determining the at least one of the plurality of vendors in accordance with stored vendor information corresponding to a geographic location associated with the vendor and a geographic location associated with the buyer.

23. The method of claim 14, wherein the lead source is kept anonymous by not identifying at least one of a name, an address, an IP address, a phone number, a facsimile number, and an email related to the lead source.

24. A non-transitory computer-readable medium carrying computer code which controls one or more processors to:
collect vendor information corresponding to a plurality of vendors, lead source information, sales lead information corresponding to a plurality of projects, and buyer information;
store the collected information in an associated database;
receive sales lead information corresponding to an imminent purchase of a good or a service from an anonymous lead source, the sales lead information including an identity of a corresponding buyer, an identification of at least one of a good or a service, a scope of work, and an identification of a current vendor associated with the identified at least one good or service;
verify the received sales lead information is representative of a new project in accordance with a comparison of the received sales lead information to sales lead information corresponding to the plurality of projects stored in the associated database;
store the verified received sales lead information as a new project in the associated database;
compare the received sales lead information to sales lead information corresponding to the plurality of projects stored in the associated database;
compare the identification of the current vendor to plurality of vendors stored in the associated database so as to identify a match therebetween in response to a result of the sales lead information comparison;
notify an identified matching vendor of the received sales lead information in accordance with a result of the comparison of the current vendor;
receive a response from the buyer corresponding to the sales lead information indicating at least one of a valid or a bogus sales lead information;
modify a value associated with the sales lead information in accordance with a response from the buyer indicating validation of the sales lead information;
communicate a portion of the sales lead information to at least one of the plurality of vendors, the portion of the sales lead information comprising the scope of work;
receive, in response to the communicated portion of the sales lead information, a purchase request from at least one vendor of the plurality thereof; and
communicate a remaining portion of the sales lead information to the at least one vendor of the plurality thereof in response to the received purchase request.
